(19) United States
(12) Patent Application Publication
(10) Pub. No.: US 2025/0209553 A1
(43) Pub. Date: Jun. 26, 2025

(54) SYSTEMS AND METHODS FOR FACILITATING COMPLETION OF REAL ESTATE TRANSACTIONS BY COLLABORATING WITH USERS

(71) Applicants: James GONZALEZ, Reading, PA (US); Damien OGDEN, Reading, PA (US)

(72) Inventors: James GONZALEZ, Reading, PA (US); Damien OGDEN, Reading, PA (US)

(21) Appl. No.: 18/390,419

(22) Filed: Dec. 20, 2023

Related U.S. Application Data
(60) Provisional application No. 63/476,313, filed on Dec. 20, 2022.

(51) Int. Cl. G06Q 50/16; G06Q 10/1093; G06Q 20/38; G06Q 20/40; G06Q 30/02

(52) U.S. Cl. CPC G06Q 50/167; G06Q 10/1095; G06Q 20/3821; G06Q 20/4014; G06Q 30/0278; G06Q 2220/00

(57) ABSTRACT

The present disclosure provides systems and methods for facilitating completion of asset transactions by collaborating with users. User credentials from a plurality of users for a digital platform are received. The plurality of users are authenticated based on their user credentials. A set of selling parameters corresponding to an asset are received from a seller. A price of the asset is dynamically estimated based at least on the set of selling parameters and similar and/or geographically closely located assets. An offer price for the asset is received from one or more buyers. A communication connection, for example, a chat is established between the plurality of users including the buyer, the seller, and optionally, an agent, a landlord, an attorney, and a service provider to facilitate the completion of the transaction of the asset via the digital platform.

### TECHNICAL FIELD

The present disclosure relates to a electronics data processing in real estate domain, and more particularly, relates to computer-implemented systems and methods for facilitating the completion of real estate transactions by collaborating with one or more users, for example, buyers, sellers, agents, attorneys, service providers, etc.

### BACKGROUND

Real estate is land along with any improvements attached to it. The improvements can be natural or man-made. Such improvements include, but are not limited to, enhancing the land with water, crops, trees, minerals, buildings, homes, fences, bridges, etc. A real estate transaction is a process of transferring a right associated with the real estate from one party to another. The right associated with real estate can be absolute ownership or specific limited interest over the real estate property. The seller can fully or partly transfer the ownership right or limited interest to other parties. For example, the owner of the real estate property can transfer the ownership to another party, by way of a sale deed or can partly transfer the limited interest of the property to another party, by way of lease or rent.

When a seller has to sell a property, they first need to advertise the details of the property in public media such as newspapers, social media, or via real estate web or mobile applications. Interested buyers can contact the seller and complete the sale. In some cases, the seller and buyer can appoint a broker or agent to facilitate the sale. To prepare and execute legal documents, like rent agreements, sale deeds, sale agreements, disclosure agreements, etc., the buyers and sellers can seek the assistance of one or more attorneys.

In the field of real estate, many web-based and mobile-based applications are available in the marketplace to facilitate real estate transactions. Some such applications are Zillow™, Redfin™, Realestate.com™, etc. However, in such applications, all real estate transactions run and operate independently and avoid sharing of information among all the parties. The real estate transaction involves numerous tasks that need to be performed by the system and/or individuals. This makes the overall transaction process complex. Some of the transactions run concurrently and some are completed only in order. Each party/user knows what they need to do and when can they complete their task, but it is hard to understand what other users in the system are doing. As an example, current real estate systems lack transparency and communication among service providers involved in real estate transactions. Further, there is a loss of time and efficiency in navigating multiple platforms for each provider involved.

The main difficulties faced by the seller in existing real estate systems are, first, the offers made by potential buyers lack transparency; second, due to lack of transparency, low-ball offers may be received; and third, sellers need to pay a commission to an agent of the buyer. Similarly, sellers, buyers, agents of the sellers, and agents of buyers face difficulties due to a lack of transparency in transactions.

The main difficulties faced by the buyer in existing real estate systems are, first, the offers made by potential buyers and acceptance of an offer lacks transparency; second, the buyer has to spend time to make multiple offers and needs to modify the offer amount frequently; and third, the seller's disclosure is not readily available all the time. It may be appreciated that the seller's disclosure may refer to a legal document regarding real estate that provides details about a property's state of condition and how it may negatively impact the value of the property.

Further, the main difficulties faced by the agent of the seller in existing real estate systems are, first, the agent has to spend time dealing with multiple offers; and second, the agent needs to answer redundant questions by the agent of the buyer.

Further, the main difficulties faced by the agent of the buyer in existing real estate systems are, first, the agent has to spend time submitting multiple offers to the seller or the agent of the seller; second, there exists a lack of transparency in offers made by other potential buyers which prevents them to help buyers to put in their best offers; and third, the agent needs to wait for a response after the decision is made.

Therefore, there exists a well-established and technological need for an improved computer-implemented system and method for facilitating completion of transactions and collaborating with users in the real estate business, that is more transparent, streamlines communication among the users, and enhances the overall efficiency in real estate transactions.

Further limitations and disadvantages of conventional and traditional approaches will become apparent to one of skill in the art, through comparison of such systems with some aspects of the present disclosure as set forth in the remainder of the present application with reference to the drawings.

### SUMMARY

To solve the foregoing problem and to provide other advantages, one aspect of the present disclosure is to provide a computer-implemented system and a method for facilitating the completion of transactions and collaborating with users in the real estate business. The system and method enable buyers, sellers, agents, attorneys, and service providers to collaborate, communicate, and complete a real estate transaction successfully.

In an aspect, the system and method allow the sellers to find an agent, an attorney, or a service provider, list a property for sale or rent with or without the agent (for sale by owner), search for the property, chat and collaborate with other users involved in the transaction, view offers for their property as soon as they are submitted by the potential buyers, and estimate a value of the property on appraisal using data analysis.

In an aspect, the system and the method allow the buyers to find the agent or the attorney, search for the property, view existing offers on the property, and chat and collaborate with other users involved in the transaction.

In an aspect, the system and the method allow the agents to invite the seller, the buyer, or the service provider, submit/accept the offer, list the property, upload, and store contracts, search for the property, view existing offers on the property, and chat and collaborate with other users involved in the transaction.

In an aspect, the system and the method allow the attorneys to close the property by reviewing documents and signing off contracts, uploading and storing legal documents, and chatting and collaborating with other users involved in the transaction.

In an aspect, the system and the method allow the service providers to find the transaction or receive an invite from the seller or the agent, set up and receive payments for their services, and chat and collaborate with other users involved in the transaction.

In an aspect, the sellers can get an estimate of the appraised value of their property based on the square footage, construction, and condition of other properties that are close to the property.

In an aspect, the present disclosure relates to a computer-implemented method, including receiving, by a processor associated with a digital platform, from a plurality of users associated with respective user devices, user credentials for the digital platform, authenticating, by the processor, the plurality of users based on the user credentials, receiving, by the processor, a set of selling parameters corresponding to an asset from a first user, of the plurality of users, associated with a first user device, dynamically estimating, by the processor, a price of the asset based at least on the set of selling parameters, displaying, by the processor, the asset and the set of selling parameters on the respective user devices of the plurality of users via the digital platform, receiving, by the processor, one or more offer prices for the asset from one or more second users, of the plurality of users, associated with one or more second user devices, and establishing, by the processor, a communication connection between the plurality of users including the first user and the one or more second users to enable the first user and the one or more second users to complete a transaction of the asset via the digital platform.

In an aspect, the price of the asset may be further based on one or more similar assets located within a predetermined area from the asset.

In an aspect, the method may further include displaying, by the processor, the one or more offer prices, received from the one or more second users, in real-time on the respective user devices of the plurality of users via the digital platform.

In an aspect, the method may further include receiving, by the processor, a query to search for an agent on the digital platform, displaying, by the processor, a list of agents associated with the digital platform based on the query, receiving, by the processor, a selection of the agent from the list of agents, associating, by the processor, the selected agent with an identifier of the transaction of the asset, and establishing, by the processor, the communication connection between the first user, the one or more second users, and the agent to facilitate the completion of the transaction of the asset.

In an aspect, the query may be received from at least one of: the first user of the first user device, and the one or more second users of the one or more second user devices.

In an aspect, the query may include at least one of: username of the agent, e-mail identifier (ID) of the agent, the identifier of the transaction, or any combination thereof.

In an aspect, establishing, by the processor, the communication connection may include receiving, by the processor, from the one or more second users, a tour request corresponding to the asset, and scheduling, by the processor, a tour of the asset based on an availability of the first user, the one or more second users, and the agent.

In an aspect, the method may further include receiving, by the processor, from the one or more second users via the agent, offer information corresponding to the one or more offer prices.

In an aspect, the offer information may include at least one of: offer price, closing date, type of funding, elected contingencies, or any combination thereof.

In an aspect, the method may further include receiving, by the processor, from the first user of the first user device via the agent, a selection of an offer price from the one or more offer prices.

In an aspect, the method may further include receiving, by the processor, from the first user of the first user device, commission amount data corresponding to the selection of the offer price.

In an aspect, the set of selling parameters may include information corresponding to at least one of: square footage, number of bedrooms, number of bathrooms, basement, Heating, Ventilation, and Air Conditioning (HVAC) system, water supply, sewage system, roof, water heater, electrical system, built year, images of the asset, location, or any combination thereof.

In an aspect, the plurality of users may include at least one of: buyers, sellers, agents of the buyers, agents of the sellers, attorneys, landlords, and service providers, wherein the first user may correspond to the sellers, and wherein the one or more second users may correspond to the buyers.

In another aspect, the present disclosure relates to a system for facilitating completion of an asset transaction, including a processor, and a memory operatively coupled with the processor, wherein the memory includes processor-executable instructions which, when executed, cause the processor to perform the methods as discussed herein.

In an aspect, the memory includes processor-executable instructions which, when executed, may further cause the processor to receive a query to search for an agent or an attorney on the digital platform, display a list of agents or attorneys associated with the digital platform based on the query, receive a selection of the agent or the attorney from the list of agents or attorneys, associate the selected agent or attorney with an identifier of the transaction of the asset, and establish the communication connection between the first user, the one or more second users, and the agent or the attorney to facilitate the completion of the transaction of the asset.

In an aspect, the memory includes processor-executable instructions which, when executed, may further cause the processor to receive, from the first user of the first user device via the selected agent, a selection of an offer price from the one or more offer prices, wherein the first user may collaborate with the plurality of users via the established communication connection corresponding to the selected offer price of the asset.

In another aspect, the present disclosure relates to a non-transitory computer-readable medium including processor-executable instructions that cause a system to perform the methods discussed herein.

An advantage of various embodiments of the present disclosure is to facilitate and assist the buyers, sellers, attorneys, agents of buyers, and agents of sellers to complete the real estate transaction seamlessly.

### BRIEF DESCRIPTION OF THE FIGURES

The following detailed description of illustrative embodiments is better understood when read in conjunction with the appended drawings. To illustrate the present disclosure, exemplary constructions of the disclosure are shown in the drawings. However, the present disclosure is not limited to a specific device, or a tool and instrumentalities disclosed herein. Moreover, those in the art will understand that the drawings are not to scale.

FIG. 1 illustrates an example networked environment in which or with which an example system may be implemented, in accordance with some embodiments of the present disclosure;

FIG. 2 is a simplified block diagram of an example server system for facilitating completion of real estate transactions by collaborating with users, in accordance with some embodiments of the present disclosure;

FIG. 3 illustrates an example user interface of a dashboard of a seller showing a list of tasks that can be performed using the networked environment of FIG. 1, in accordance with some embodiments of the present disclosure;

FIG. 4 illustrates an example user interface of a dashboard of a buyer showing a list of tasks that can be performed using the networked environment of FIG. 1, in accordance with some embodiments of the present disclosure;

FIG. 5 illustrates an example user interface of a dashboard of an agent showing a list of tasks that can be performed using the networked environment of FIG. 1, in accordance with some embodiments of the present disclosure;

FIG. 6 illustrates an example user interface of a dashboard of an attorney showing a list of tasks that can be performed using the networked environment of FIG. 1, in accordance with some embodiments of the present disclosure;

FIG. 7 illustrates an example user interface of a dashboard of a service provider showing a list of tasks that can be performed using the networked environment of FIG. 1, in accordance with some embodiments of the present disclosure;

FIG. 8 illustrates a flow chart of an example method performed by the seller for viewing existing offers on a real estate property and completing the transaction successfully by connecting with an agent and an attorney, using the networked environment of FIG. 1, in accordance with some embodiments of the present disclosure;

FIG. 9 illustrates a flow chart of an example method performed by the seller or a landlord for selling the property without connecting with the agent, using the networked environment of FIG. 1, in accordance with some embodiments of the present disclosure;

FIG. 10 illustrates a flow chart of an example method performed by the buyer showing a process from creating a profile to purchasing the real estate property by connecting to the agent and the attorney, using the networked environment of FIG. 1, in accordance with some embodiments of the present disclosure;

FIG. 11 illustrates a flow chart of an example method performed by the agent showing a process from listing the real estate property to submitting or accepting an offer, using the networked environment of FIG. 1, in accordance with some embodiments of the present disclosure;

FIG. 12 illustrates a flow chart of an example method performed by the attorney for completing the transaction by reviewing, signing off a contract, and closing the real estate property, using the networked environment of FIG. 1, in accordance with some embodiments of the present disclosure;

FIG. 13 illustrates a flow chart of an example method performed by a service provider for offering services through the platform and accepting payments for their services, using the networked environment of FIG. 1, in accordance with some embodiments of the present disclosure; and

FIGS. 14A-14D illustrate representations of example user interfaces associated with the system of FIG. 1, in accordance with some embodiments of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

Various examples of the present disclosure provide computer-implemented systems and methods for facilitating completion of real estate transactions by collaborating with one or more users. The present disclosure allows one or more users, for example, buyers, sellers, agents, attorneys, service providers, etc. after registering at a platform to collaborate and work together in a real estate transaction from their respective dashboard and facilitate other users to successfully complete the real estate transaction.

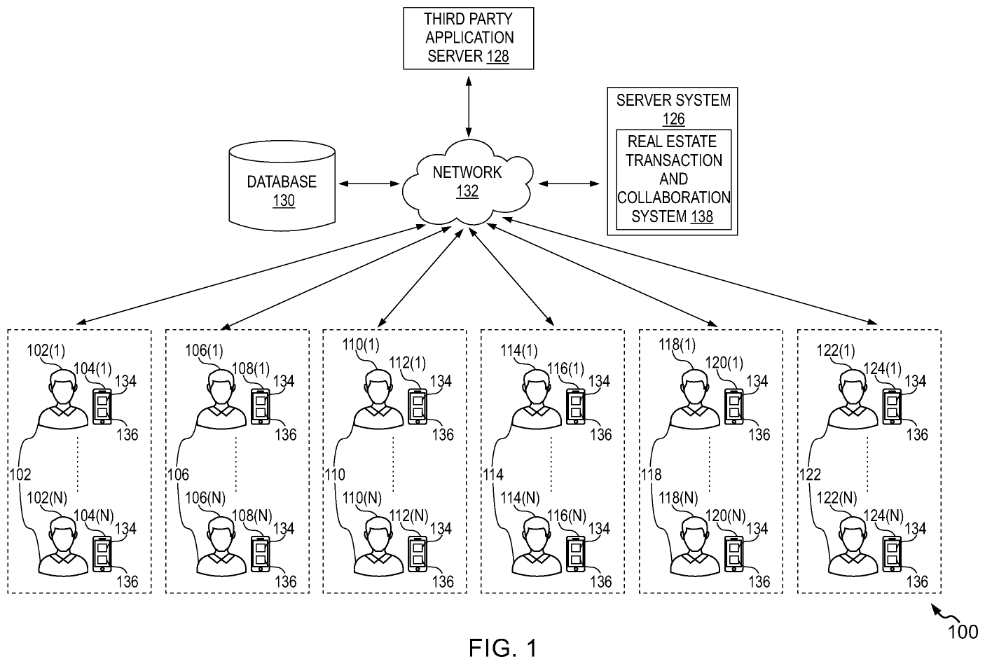

Various embodiments of the present invention are described hereinafter with reference to FIG. 1 to FIG. 14D.

FIG. 1 illustrates an example networked environment 100 in which or with which embodiments of the present disclosure may be implemented. Although the networked environment 100 is presented in one arrangement, other embodiments may include the parts of the environment 100 (or other parts) arranged otherwise depending on, for example, for facilitating completion of real estate transactions by collaborating with users.

Referring to FIG. 1, the networked environment 100 generally includes a plurality of entities, for example, a plurality of buyers 102, a plurality of sellers 106, a plurality of agents 110, 114, a plurality of attorneys 118, and a plurality of service providers 122. The plurality of buyers 102 includes a buyer 102(1) through a buyer 102(N), respectively associated with a user device 104(1) through a user device 104(N). It should be noted that for ease of reference, the plurality of buyers 102 is referred to as ‘buyers 102’, and any of the buyers 102(1) through 102(N) is singularly referred to as ‘buyer 102(1)’ throughout the disclosure. The plurality of sellers 106 includes a seller 106(1) through a seller 106(N), respectively associated with a user device 108(1) to a user device 108(N). For ease of reference, the plurality of buyers 106 is referred to as ‘sellers 106’, and any of the sellers 106(1) through 106(N) is singularly referred to as ‘seller 106(1)’ throughout the disclosure. The plurality of agents 110 of the buyers 102 includes an agent 110(1) through an agent 110(N), respectively associated with a user device 112(1) through a user device 112(N). For ease of reference, the plurality of agents 110 of the buyers 102 is referred to as ‘agents 110’, and any of the agents 110(1) through 110(N) is singularly referred to as ‘agent 110(1)’ throughout the disclosure. The plurality of agents 114 of the sellers 106 includes an agent 114(1) through an agent 114(N), respectively associated with a user device 116(1) through a user device 116(N). It should be noted that for ease of reference, the plurality of agents 114 of the sellers 106 is referred to as ‘agents 114’, and any of the agents 114(1) through 114(N) is singularly referred to as ‘agent 114(1)’ throughout the disclosure. The plurality of attorneys 118 includes an attorney 118(1) through an attorney 118(N), respectively associated with a user device 120(1) through a user device 120(N). For ease of reference, the plurality of attorneys 118 is referred to as ‘attorneys 118’, and any of the attorneys 118(1) through 118(N) is singularly referred to as ‘attorney 118’ throughout the disclosure. The plurality of service providers 122 includes a service provider 122(1) through a service provider 122(N), respectively associated with a user device 124(1) through a user device 124(N). For ease of reference, the plurality of service providers 122 is referred to as ‘service providers 122’, and any of the service providers 122(1) through 122(N) is singularly referred to as ‘service provider 122’ throughout the disclosure. Referring to FIG. 1, the networked environment 100 further includes a server system 126, a third-party application server 128, and a database 130.

The buyers 102, the sellers 106, the agents 110, 114, the attorneys 118, the service providers 122, the server system 126, the third-party application server 128, and the database 130 are coupled to, and in communication with (and/or with access to) a network 132. The network 132 may include, without limitation, a Light Fidelity (Li-Fi) network, a Local Area Network (LAN), a Wide Area Network (WAN), a Metropolitan Area Network (MAN), a satellite network, the Internet, a fiber-optic network, a coaxial cable network, an Infrared (IR) network, a Radio Frequency (RF) network, a virtual network, and/or another suitable public and/or private network capable of supporting communication among the entities illustrated in FIG. 1, or any combination thereof.

Various entities in the environment 100 may connect to the network 132 in accordance with various wired and wireless communication protocols, such as Transmission Control Protocol and Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, or any combination thereof. For example, the network 132 may include multiple different networks, such as a private network made accessible by the user devices 104(1)-104(N), 108(1)-108(N), 112(1)-112(N), 116(1)-116(N), 120(1)-120(N), and 124(1)-124(N), the server system 126, and the database 130 separately, and a public network (e.g., Internet) through which the user devices 104(1)-104(N), 108(1)-108(N), 112(1)-112(N), 116(1)-116(N), 120(1)-120(N), and 124(1)-124(N), the server system 126, and the database 130 may communicate.

In one example scenario, the buyers 102 may refer to persons who are interested to buy a real estate property or who wish to possess a specific interest in the real estate property for a specific period from a seller, for example, the seller 106(1). In some embodiments, the buyers 102 may register at the platform 134 to avail services in the form of sale, lease, rent, etc. from the seller 106(1), the agent 110(1), 114(1), the attorney 118(1), etc.

In one example scenario, the sellers 106 may refer to persons who own the real estate property absolutely or have a specific interest in the real estate property. In some embodiments, the sellers 106 may register at the platform 134 to transfer the real estate property to another party, for example, the buyers 102, in the form of sale, lease, rent, etc.

In one example scenario, the agents 110 of the buyer 102 may refer to persons who assist the buyer 102, in availing the real estate property of their choice, for consideration in the form of a commission amount arising out of a transaction amount. In an embodiment, the agents 110 of the buyer 102 may register at the platform 134 and the agents 110 may be selected by the buyer 102 to assist in the purchase, lease, rent, etc., of the real estate property.

In one example scenario, the agents 114 of the seller 106 may refer to persons who assist the seller 106 to sell, rent, or lease the real estate property, for consideration in the form of a commission amount arising out of the transaction amount.

In one example scenario, the attorneys 118 may refer to persons who are legal professionals and assist the seller 106 and/or the buyer 102 in preparing conveyance documents and assist in verifying legal documents that are related to the conveyance of the real estate property. The attorneys 118 may be remunerated for the professional legal service offered to the seller 106 and/or the buyer 102, when the real estate transaction or professional services related to the real estate transaction is completed successfully.

In one example scenario, the service providers 122 may refer to persons who can offer services through the platform 134 and can accept payments for the services rendered by them. In an embodiment, the service providers 122 may include, but are not limited to, contractors, pest control agencies, land appraisers, Heating, Ventilation, and Air Conditioning (HVAC) companies, painters, goods packers and movers, insurance companies, septic companies, notaries, photographers, lenders, title companies, etc.

Some examples of the user devices 104(1)-104(N), 108(1)-108(N), 112(1)-112(N), 116(1)-116(N), 120(1)-120(N), and 124(1)-124(N) may include, but are not limited to, laptops, smartphones, desktops, tablets, workstation terminals, an Ultra-Mobile Personal Computer (UMPC), a phablet computer, a handheld personal computer, and the like.

It should be noted that the number of user devices 104(1)-104(N), 108(1)-108(N), 112(1)-112(N), 116(1)-116(N), 120(1)-120(N), and 124(1)-124(N), described herein are only used for exemplary purposes and do not limit the scope of the invention. The main objective of the invention is to provide a unified platform 134 for facilitating the completion of real estate transactions by collaborating the buyers 102, the sellers 106, the agents 110 of the buyers 102, the agents 114 of the sellers 106, the attorneys 118, and the service providers 122 at one place. In particular, the platform 134 enables to establish a communication connection between the plurality of users to allow the plurality of users such as the buyers 102, the sellers 106, the agents 110 of the buyers 102, the agents 114 of the sellers 106, the attorneys 118, and the service providers 122 to communicate with each other to complete a real estate transaction. Further, the present invention provides transparency in real estate transactions, that is, transparency in offers made by other potential buyers and acceptance of the offers.

Each of the user devices 104(1)-104(N), 108(1)-108(N), 112(1)-112(N), 116(1)-116(N), 120(1)-120(N), and 124(1)-124(N) has a real estate application 134 and a third-party application 136. In at least one embodiment, the real estate application 134 may be accessed through the third-party application 136 hosted and managed by the third-party application server 128 via the network 132. Typically, the third-party application 136 may create a contractual agreement with the real estate application 134 to comply with the privacy and security requirements of the real estate application 134. Based on the contractual agreement, the server system 126 including a real estate transaction and collaboration system 138 may provide access to real estate services for the third-party application server 128 through integrated Application Programming Interface (API) services. In other words, the real estate application 134 may be a plugin for the third-party application 136. In an embodiment, the real estate application 134 may be implemented as operating system extensions, modules, plugins, and the like. Further, the real estate application 134 may be operative in cloud infrastructure, or the real estate application 134 may be executed within or as a Virtual Machine (VM) or virtual server that may be managed in the cloud infrastructure. It may be appreciated that the real estate application 134 may be interchangeably referred to as a digital platform throughout the disclosure.

In an embodiment, the server system 126 may be deployed as a standalone server or may be implemented in the cloud as Software as a Service (SaaS). The digital platform or the real estate application 134 associated with the server system 126 may provide or host the digital platform 134 for facilitating the completion of the real estate transaction by collaborating with the buyers 102, the sellers 106, the agents 110 of the buyers 102, the agents 114 of the sellers 106, the attorneys 118, and the service providers 122. An instance of the digital platform 134 may also be accessible to each of the user devices 104(1)-104(N), 108(1)-108(N), 112(1)-112(N), 116(1)-116(N), 120(1)-120(N), and 124(1)-124(N), as shown in FIG. 1. This enables the buyers 102, the sellers 106, the agents 110 of the buyers 102, the agents 114 of the sellers 106, the attorneys 118, and the service providers 122 to access the real estate transaction and collaboration system 138 of the server system 126 on the user devices 104(1)-104(N), 108(1)-108(N), 112(1)-112(N), 116(1)-116(N), 120(1)-120(N), and 124(1)-124(N), respectively. The digital platform or the real estate application 134 may refer to a set of computer-executable instructions configured to enable User Interfaces (UIs) of the user devices 104(1)-104(N), 108(1)-108(N), 112(1)-112(N), 116(1)-116(N), 120(1)-120(N), and 124(1)-124(N) to subscribe, collaborate with other users, and complete real estate transactions. The digital platform 134 may also be configured to provide UIs enabling the buyers 102, the sellers 106, the agents 110 of the buyers 102, the agents 114 of the sellers 106, the attorneys 118, and the service providers 122 to complete real estate transactions. In an embodiment, the real estate transaction and collaboration system 138 associated with the server system 126 may provide the digital platform 134, in response to a request received from the user devices 104(1)-104(N), 108(1)-108(N), 112(1)-112(N), 116(1)-116(N), 120(1)-120(N), and 124(1)-124(N) via the network 132. In another embodiment, the digital platform 134 may be factory-installed on the user devices 104(1)-104(N), 108(1)-108(N), 112(1)-112(N), 116(1)-116(N), 120(1)-120(N), and 124(1)-124(N). In an embodiment, the server system 126 may provide the digital platform 134 as a web service accessible through a website. In such a scenario, the digital platform 134 may be accessed through the website over the network 132 using a web browser application (e.g., Google Chrome®, Safari®, Mozilla Firefox™, Opera™, Microsoft Edge®, etc.) installed in the user devices 104(1)-104(N), 108(1)-108(N), 112(1)-112(N), 116(1)-116(N), 120(1)-120(N), and 124(1)-124(N).

In an embodiment, the server system 126 may be embodied in at least one computing device in communication with the network 132 and/or embodied in at least one non-transitory computer-readable media. The real estate transaction and collaboration system 138 associated with the server system 126 may be configured to allow the buyers 102, the sellers 106, the agents 110 of the buyers 102, the agents 114 of the sellers 106, the attorneys 118, and the service providers 122 to complete the real estate transactions successfully, by collaborating with each other.

In an embodiment, the database 130 may be a separate entity (or an external database) that is in communication with the server system 126 via the network 132. The database 130 may be configured to store information related to buyer-related data, seller-related data, agent-related data, attorney-related data, service provider-related data, etc. In an embodiment, the database 130 may store real estate property details such as location, size, amenities, photographs, floor plans, neighborhood information, offer prices, etc. The database 130 may enable the buyers 102, the sellers 106, the agents 110 of the buyers 102, the agents 114 of the sellers 106, the attorneys 118, and the service providers 122 to easily search, sort, and retrieve relevant property listings based on their preferences, providing a dynamic database of real estate assets. In an embodiment, the database 130 may maintain a centralized repository of information related to various services provided by service providers 122 associated with asset transactions. The users may access this database 130 to connect with relevant service providers 122, ensuring a smooth and a comprehensive experience throughout the buying or selling journey. In an embodiment, the database 130 may serve as a centralized repository for essential real estate documents and processes. In an embodiment, the database 130 may facilitate client relationship management, by way of efficient lead management and customer management to keep a track of user activities, interactions, and preferences, providing real-time insights to users.

The real estate transaction and collaboration system 138 associated with the server system 126 may be configured to receive a service request for performing real estate transactions and collaborating with other users of the digital platform 134 and using the professional and technical skills of other users of the system 138 via the digital platform 134. The plurality of users (the buyers 102, the sellers 106, the agents 110 of the buyers 102, the agents 114 of the sellers 106, the attorneys 118, and the service providers 122) may provide inputs in the digital platform 134 to avail the online real estate services associated with the server system 126, which in turn, triggers the service request to the server system 126. The real estate transaction and collaboration system 138 may provide an interface in the digital platform 134 for authenticating the buyers 102, the sellers 106, the agents 110 of the buyers 102, the agents 114 of the sellers 106, the attorneys 118, and the service providers 122 based at least on their respective user credentials (e.g., email address). In other words, the real estate transaction and collaboration system 138 may determine the buyers 102, the sellers 106, the agents 110 of the buyers 102, the agents 114 of the sellers 106, the attorneys 118, and the service providers 122, as a licensed user based on the user credentials for performing the real estate transaction in the digital platform 134. In an embodiment, the database 130 may contain information (e.g., user credentials) necessary to authenticate the plurality of users. A person of ordinary skill in the art will understand that the credentials may include a means for generating an authenticated reference to a single account identifier. For example, the credentials may include, but not be limited to, a user generated username and password, a mobile phone number, a Personal Identification Number (PIN), and a biometric signature that may be associated with the same profile data of the user for accessing the digital platform 134. If a user is successfully authenticated, the system 138 may route the user to the digital platform 134 to perform a desired service for the user. In an embodiment, the user credentials may be associated with user profile information such as, but not limited to, the user's e-mail address, user preferences, and application version installed on the user devices 104(1)-104(N), 108(1)-108(N), 112(1)-112(N), 116(1)-116(N), 120(1)-120(N), and 124(1)-124(N), so that each time the user logs into the digital platform 134, the associated user profile information is available with the digital platform 134. This user profile information allows the user to enter the information once and use that same information during subsequent logins to the digital platform 134. By maintaining the user profile information, the system 138 may be able to share pertinent information with the digital platform 134 to speed registration and enable access to services.

In an embodiment, the plurality of users may use the digital platform 134 to, but not limited to, buy or sell assets, view information related to the assets rendered by the digital platform 134, update real-time information about the assets, submit offers for the assets, and the like. It may be appreciated that real estate property is referred herein for exemplary purposes, and the networked environment 100 may be implemented for any asset including, but not limited to, real estate properties, auction houses, estate auctions, commercial properties, malls, business sales, luxury planes, cars, boats, planes, and the like.

In an embodiment, a set of selling parameters corresponding to a real estate asset may be received, by the digital platform 134 from a first user (for example, the seller 106) of a first user device (for example, user device 108). In an embodiment, the set of selling parameters corresponding to the real estate asset may be fetched from the database 130 (or Multiple Listing Service (MLS)). In another embodiment, the set of selling parameters may be entered on the digital platform 134 by the first user 106 using their user device 108. The set of selling parameters may include information corresponding to, but not limited to, square footage, number of bedrooms, number of bathrooms, basement, HVAC, water supply, sewage system, roof, water heater, electrical system, built year, images of the asset, location, or any combination thereof. In an embodiment, the first user 106 may opt to sell their real estate asset using an agent 114. In another embodiment, the first user 106 may opt to sell their real estate asset on their own. In such embodiments, the first user 106 may find an agent 114 at any instance during the process of real estate transaction via the digital platform 134.

The first user 106 may be able to find the agent 114 by submitting a query on the digital platform 134. The query may include, but is not limited to, username of the agent 114, email ID of the agent, an identifier of a transaction of the real estate asset, or any combination thereof. If the agent 114 is already registered on the digital platform 134, a list of agents matching the query may be extracted from the database 130 and displayed on the first user device 108 of the first user 106. If the agent 114 is not registered, an invitation to register on the digital platform 134 may be sent by the first user 106 to their email ID or contact number. In an embodiment, the selected agent 114 may be associated with the identifier of the transaction of the real estate asset such that a communication connection may be established between the first user 106 and the agent 114 to facilitate the completion of the transaction of the real estate asset.

In an embodiment, a price of the real estate asset may be dynamically estimated by the digital platform 134. In an embodiment, the price of the real estate asset may be estimated based at least on the set of selling parameters corresponding to the real estate asset. Alternatively, or additionally, in an embodiment, the price of the real estate asset may be estimated based on one or more similar real estate assets located within a predetermined area from the real estate asset that the first user 106 wishes to offer for sale or rent. In an embodiment, the set of selling parameters may be modified by the first user 106. Accordingly, the price of the real estate asset may be dynamically estimated based on the modified set of selling parameters. In an embodiment, commission amount data may be received by the digital platform 134 from the first user 106 of the first user device 108. The commission amount data may refer to an amount of buyer's commission that the seller 106 may provide in case of a successful transaction of the real estate asset. Thereafter, the real estate asset and the corresponding set of selling parameters may be displayed to the plurality of users (the buyers 102, the sellers 106, the agents 110 of the buyers 102, the agents 114 of the sellers 106, the attorneys 118, and the service providers 122) on their respective user devices (104, 108, 112, 116, 120, and 124) via the digital platform 134.

In an embodiment, a second user (for example, buyer 102) may look for real estate assets on the digital platform 134 to purchase. In an embodiment, the second user 102 may provide user-specific information corresponding to one or more preferences with respect to a desired real estate asset. In an embodiment, the real estate transaction and collaboration system 138 may utilize Artificial Intelligence (AI) to provide recommendations of real estate assets based on, but not limited to, user preferences, user location, user's historical purchase/selling pattern, and the like. By leveraging machine learning algorithms and data mining techniques, the system 138 may suggest assets that closely match a user's requirements and preferences. The system 138 may take into account user-specific information or preferences such as, but not limited to, location, amenities, price range, and historical data to provide accurate and relevant recommendations. The system 138 may continually adapt and refine recommendations based on user feedback, providing a more intuitive and tailored user experience. In an embodiment, the digital platform 134 may display a list of one or more other real estate assets based on, but not limited to, the one or more preferences of the second user 102 and a location of their user device 104. In an embodiment, the digital platform 134 may provide a search functionality to the second user 102 to be able to search for specific assets. The digital platform 134 may enable the second user 102 to mark the real estate assets on wish list. This facilitates the second user 102 to get notifications or alerts for the wish listed real estate assets.

In an embodiment, the second user 102 may view the real estate assets on the digital platform 134 without registration. The second user 102 may be prompted by the digital platform 134 to enter whether they are working with an agent 110. In case the second user 102 is working with the agent 110, the second user 102 may be requested to login and/or register on the digital platform 134 to find their agent 110 (by submitting the query on the digital platform 134) or at least invite their agent 110 to register on the digital platform 134, and establish the communication connection between the first user 106, the second user 102, and the agents 110, 114 to enable the users to communicate with each other via the digital platform 134. If the second user 102 is not working with any agent 114, the digital platform 134 may enable the second user 102 to find a suitable agent 110 by submitting the query at any instance during the process of the transaction of the real estate asset. In any case, with or without the agent 110, the second user 102 may submit offer information corresponding to the real estate asset that they are interested in for purchase or rent. The offer information may include, but not be limited to, offer price, closing date, type of funding, elected contingencies, or any combination thereof. In an embodiment, a tour request may be received by the digital platform 134 from the second user 102 or from the agent 110 of the second user 102 to visit the real estate asset. Based on an availability of the first user 106 and/or the agent 114, and the second user 102 and/or the agent 110, a physical visit to the real estate asset may be scheduled in their respective calendars on the digital platform 134. In an embodiment, a virtual visit corresponding to the real estate asset may be scheduled via the digital platform 134. The digital platform 134 may implement Global Positioning System (GPS) techniques to assist the second user 102 and/or the agents 110, 114 in reaching an exact location of the real estate asset. In an embodiment, notifications corresponding to estimated time of arrival may be provided for the same. After the visit, an offer price may be submitted by the second user 102 and/or their agent 110 for the real estate asset. In an embodiment, all the offer prices for the real estate asset received from the second users 106 may be displayed to the first user 106 in real-time. In an embodiment, the offer prices on a particular real estate asset may be visible to all the users of the digital platform 134 to make an informed decision.

The first user 106 may select the best or optimal offer price for the real estate asset via the digital platform 134. The digital platform 134 may automatically mark the real estate asset as being sold.

In an embodiment, based on the established communication connection between the users, the first user 106 may send messages to any other user (agents 110, 114, second user 106, or the like) for any consultation or decision on the offer prices. In an embodiment, the first user 106 and/or the second user 102 may associate an attorney 118 on the digital platform 134 with the transaction of the real estate asset to facilitate in the completion of the transaction of the real estate asset. In an embodiment, the first user 106 and/or the second user 102 may locate service providers 122 for services required before or during the transaction of the real estate asset. The service providers 118 may include, but are not limited to, contractors, pest control service providers, appraisers, HVAC companies, painters, movers, agents, attorneys, insurance companies, septic companies, notaries, photographers, lenders, title companies, and the like. In an example embodiment, the digital platform 134 may retrieve real-time mortgage rates, loan terms, and other relevant financial information, empowering the second user 102 to make informed decisions during the buying process. In an embodiment, the database 130 may serve as a centralized repository of information related to various services associated with real estate asset transactions. For example, the database 130 may include a business directory of professional and ancillary services that may be needed for the users to move into a new real estate asset including, but not limited to, furniture, and/or getting current real estate asset prepared for sale.

Therefore, the present disclosure provides a unified interface to seamlessly integrate all aspects of the buying and selling process in near real-time, and for the plurality of users to efficiently and seamlessly collaborate with each other to facilitate the completion of the transaction of the real estate assets.

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device is shown in FIG. 1 may be implemented as multiple, distributed systems or devices. Additionally, or alternatively, a set of systems (e.g., one or more systems) or a set of devices (e.g., one or more devices) of the environment 100 may perform one or more functions described as being performed by another set of systems or another set of devices of the environment 100.

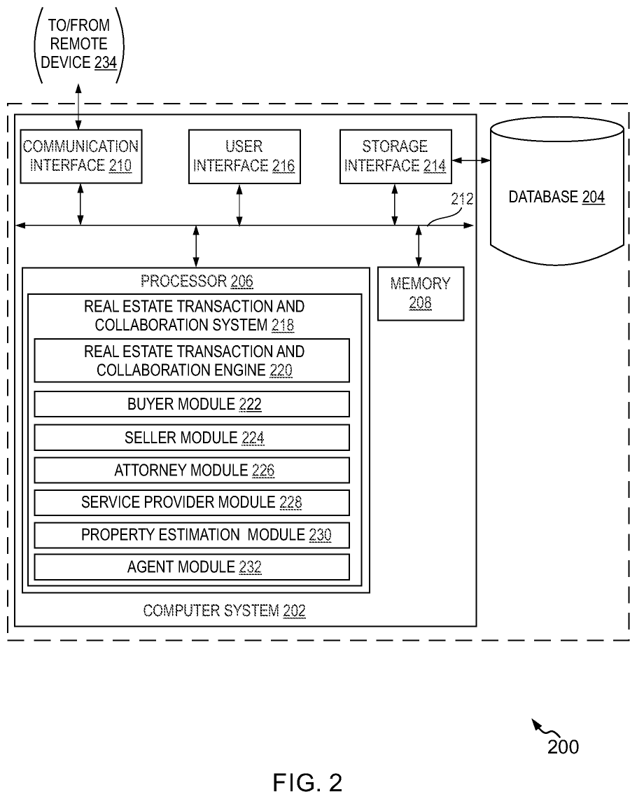

FIG. 2 is a simplified block diagram of a server system 200 for facilitating the completion of real estate transactions by collaborating with users, in accordance with an embodiment of the present disclosure. The server system 200 is an example of the server system 126 of FIG. 1. In an embodiment, the server system 200 is embodied as a cloud-based and/or SaaS-based architecture. Typically, the server system 200 may use pipeline architectures for facilitating the completion of real estate transactions by collaborating with users.

Referring to FIG. 2, the server system 200 includes a computer system 202 and a database 204. The computer system 202 includes at least one processor 206 for executing instructions, a memory 208, a communication interface 210, a storage interface 214, and a User Interface (UI) 216 that communicate with each other via a centralized circuit system 212.

In an embodiment, the database 204 is integrated within the computer system 202. For example, the computer system 202 may include one or more hard disk drives as the database 204. In one embodiment, the database 204 is integrated within the computer system 202 and configured to store an instance of the real estate application 134. The storage interface 214 is any component capable of providing the processor 206 with access to the database 204. The storage interface 214 may include, for example, an Advanced Technology Attachment (ATA) adapter, a Serial ATA (SATA) adapter, a Small Computer System Interface (SCSI) adapter, a Redundant Array of Inexpensive Disks (RAID) controller, a Storage Area Network (SAN) adapter, a network adapter, and/or any component providing the processor 206 with access to the database 204.

The UI 216 is in communication with the database 204. The UI 216 is configured to present one or more UIs at the user devices 104(1)-104(N), 108(1)-108(N), 112(1)-112(N), 116(1)-116(N), 120(1)-120(N), and 124(1)-124(N) for facilitating the completion of online real estate transactions by collaborating with users including, but not limited to, the buyers 102, the sellers 106, the agents 110 of the buyers 102, the agents 114 of the sellers 106, the attorneys 118, and the service providers 122. Typically, the UI 216 allows the server system 200 to communicate with the real estate application 134 in the user devices 104(1)-104(N), 108(1)-108(N), 112(1)-112(N), 116(1)-116(N), 120(1)-120(N), and 124(1)-124(N) for facilitating the completion of online real estate transaction by collaborating with users, not limited to, the buyers 102, the sellers 106, the agents 110 of the buyers 102, the agents 114 of the sellers 106, the attorneys 118, and the service providers 122.

The processor 206 includes a suitable logic, circuitry, and/or interfaces to execute computer-readable instructions for performing one or more operations for facilitating online real estate transactions. Examples of the processor 206 include, but are not limited to, an Application-Specific Integrated Circuit (ASIC) processor, a Reduced Instruction Set Computing (RISC) processor, a Complex Instruction Set Computing (CISC) processor, a Field-Programmable Gate Array (FPGA), and the like. Among other capabilities, the processor 206 may be configured to fetch and execute computer-readable instructions stored in the memory 208. The memory 208 may be configured to store one or more computer-readable instructions or routines in a non-transitory computer readable storage medium, which may be fetched and executed to create or share data packets over a network service. The memory 208 includes suitable logic, circuitry, and/or interfaces to store a set of computer-readable instructions for performing operations. Examples of the memory 208 include a Random-Access Memory (RAM), a Read-Only Memory (ROM), a removable storage drive, a Hard Disk Drive (HDD), and the like. It will be apparent to a person skilled in the art that the scope of the disclosure is not limited to realizing the memory 208 in the server system 200, as described herein. In another embodiment, the memory 208 may be realized in the form of a database server or cloud storage working in conjunction with the server system 200, without departing from the scope of the present disclosure.

The processor 206 is operatively coupled to the communication interface 210 such that the processor 206 is capable of communicating with a remote device 234 such as, the user devices 104(1)-104(N), 108(1)-108(N), 112(1)-112(N), 116(1)-116(N), 120(1)-120(N), and 124(1)-124(N) and the third-party application server 128 or communicate with any entity connected to the network 132 (as shown in FIG. 1).

It is noted that the server system 200 as illustrated and hereinafter described is merely illustrative of an apparatus that could benefit from embodiments of the present disclosure and, therefore, should not be taken to limit the scope of the present disclosure. It is noted that the server system 200 may include fewer or more components than those depicted in FIG. 2.

In one embodiment, the server system 200 includes the processor 206 and a real estate transaction and collaboration system 218. The real estate transaction and collaboration system 218 is an example of the real estate transaction and collaboration system 138 of FIG. 1. The real estate transaction and collaboration system 218 includes a real estate transaction and collaboration engine 220, a buyer module 222, a seller module 224, an attorney module 226, a service provider module 228, a property estimation module 230, and an agent module 232.

The buyer module 222 allows the buyer 102 to choose the asset listed by the seller 106 of their agent 110. The buyer 102 can work independently using the platform 134 or avail help from the agent 110. In case the buyer 102 has been working with the agent 110 before, the buyer 102 can search for the agent 110 on the digital platform 134 or send an invitation to the agent 110 using, but not limited to, email or contact number of the agent 110. Any registered user may locate another registered user by name, email, user ID, or transaction ID (if they are authorized). If the buyer 102 is not working with the agent 110, then the platform 134 may help the buyer 102 find an agent 110 after taking a few details of the buyer 102. The buyer 102 can schedule a tour of the real estate asset and an alert may be sent to the respective agent 110 of the buyer 102.

The seller module 224 allows the seller 106 to sell their asset using the agent 114 or opt to sell the asset on their own. At any time during the process, if the seller 106 likes to include the agent 114, they may search for the agent 114 using the digital platform 134, as discussed herein. The agent 114, or the attorney 118 may be found and linked to a real estate asset transaction by searching their user names or sending an invite to their email ID or contact number. The information about the real estate asset may be fetched from the database 204 (e.g., MLS) or may be entered by the seller 106. The MLS may refer to a database established by cooperating real estate agents, for example, the agents 110 or 114, to provide data about assets for sale. The MLS allows the agents 110 or 114 to see one another's listings of assets for sale to connect the buyer 102 to the seller 106. Under this arrangement, both the listing and selling agents 110, 114 benefit by consolidating and sharing information and by sharing commissions.

The present disclosure provides a more accurate estimate to the seller 106 based on the data of other assets that are similar and close to the seller's asset. Further, the present invention also assists in determining what asset should be sold and rented. The present invention allows users to filter the results by selecting options from the main list of categories. Further, the first user or seller 106 can change selling parameters in their dashboard on the digital platform 134 and the price of the asset gets dynamically reflected based on the options selected by the first user 106. The seller 106 may be able to see the offer prices made on their asset in real-time. The seller 106 may also send messages to their agent 114, the attorney 118, and the second user or buyer (on authorization) 102 once a communication connection (e.g., via chat) has been established for any consultation or decision on the offer prices. Users can also find service providers 122 to make home repairs or improvements if needed by their user name or by sending an invite to their email ID or contact number.

The attorney module 226 allows the attorney 118 registered with the platform 134 to connect to the buyer 102, or the seller 106 using their user name, email, or contact number. If the attorney 118 did not register with the invite of the buyer 102 or the seller 106, they may specify if they represent the buyer 102, the seller 106, or a landlord. The attorney 118 may get a notification if a contract is submitted for review. Once the offer price is accepted, the attorney 118 may be sent an alert to sign off the contract and close the transaction of the real estate asset. Once an offer price is accepted and confirmed, a transaction ID may be issued by the digital platform 134, which may be used to invite any other user that will be involved in the transaction. All users in a specific transaction may be able to communicate with one another in a group-like chat based on the established communication connection to monitor the progress of the transaction, where updates will be sent to all the involved users.

The service provider module 228 allows the service providers 122 to collaborate with other users of the system 138. The service providers 122 may choose at least one industry and/or at least one service offered by them, from a list of industries and services shown on the digital platform 134. The industries and the services selected by the service providers 122 may be verified by the digital platform 134 when necessary relevant documents such as credentials/insurance information, or certification if any, are uploaded by the service providers 122 to become verified service providers.

The property estimation module 230 helps the sellers 106 to estimate a real estate asset's appraisal value based on the selling parameters of the assets that are similar and closely located to the asset: 1) square footage value of the asset; 2) number of bedrooms in the asset; 3) number of bathrooms in the asset; 4) basement details, that is whether finished or unfinished; 5) age, type, condition of the HVAC system; 6) type of sewage system used in the asset, for example, public, septic, cesspool or other options; 7) type of water supply, for example, well, public, or other options; 8) age of roof of the asset; 9) electrical (fuses, circuit breakers); 10) age, type of water heater; 11) year at which the asset was built or newly constructed; 11) details related to the condition of the asset such as the requirement of rehab of light can be major, poor, fair, average, above average, etc. It should be noted that the property estimation module 230 may have one or more algorithms to estimate the appraisal value.

The agent module 232 helps the seller 106, or the buyer 102 to complete the real estate transaction. This can be done in multiple ways. The agents 110, 114 may be invited by the seller 106 or the buyer 102 using an email ID or a contact number. Alternatively, the agents 110, 114 may search for a user (seller 106/buyer 102) with their user name on the digital platform 134. Once the agent 114 of the seller 106 is linked to the seller 106, they should be able to enter the property information using MLS. Using this, the digital platform 134 may help the seller 106 to determine listing/offer/rental price based on specific selling parameters. The agents 110, 114 may upload and store their agency agreements in the platform 134 at the time of profile creation. The agent 110 of the buyer 102 may communicate with the buyer 102 and schedule a visit to the asset by opening slots in the calendar. Upon the buyer's confirmation, the agent 110 may submit an offer price for the seller's asset. The agent 110 may be prompted to enter specific offer information on all offer prices submitted and accepted such as, offer price, closing date, type of funding, and which contingencies were elected, if any. Information on current offer prices for the asset may be visible to the registered users only. The offer end date may be visible to all, including unregistered users. Any appraisal done on the asset may be updated on the platform 134. Once the agent 110 of the buyer 102 submits the offer price, the agent 114 of the seller 106 may communicate with the seller 106 and accept the best offer price.

It should be noted that components, described herein, can be configured in a variety of ways, including electronic circuitries, digital arithmetic and logic blocks, and memory systems in combination with software, firmware, and embedded technologies.

For example, the real estate transaction and collaboration engine 220 includes suitable logic and/or interfaces for facilitating the buyers 102, the sellers 106, the agents 110 of the buyers 102, the agents 114 of the sellers 106, the attorneys 118, and the service providers 122 to complete real estate transaction by collaborating them on the real estate application or the digital platform 134 offered by the real estate transaction and collaboration system 218. More specifically, the real estate transaction and collaboration engine 220 may receive a service request to perform and complete real estate transactions by collaborating with the buyers 102, the sellers 106, the agents 110 of the buyers 102, the agents 114 of the sellers 106, the attorneys 118, and the service providers 122 with the server system 200. It is to be noted that the service request may be triggered from the real estate application 136 available on the user devices 104(1)-104(N), 108(1)-108(N), 112(1)-112(N), 116(1)-116(N), 120(1)-120(N), and 124(1)-124(N) based on user inputs related to the transaction of real estate asset.

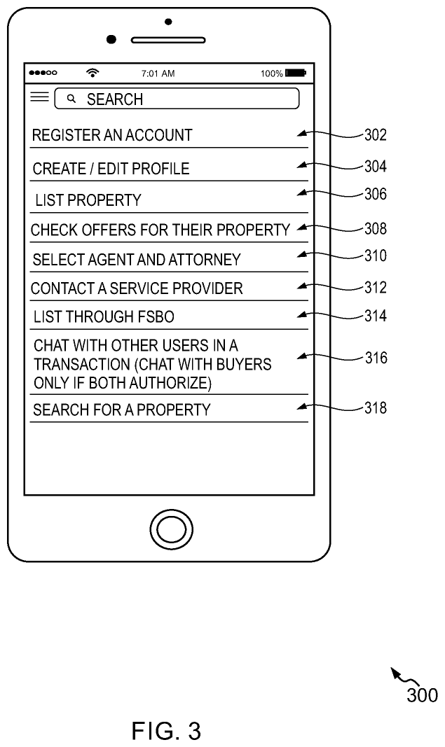

FIG. 3 illustrates a dashboard 300 of the seller 106 showing a list of tasks 302, 304, 306, 308, 310, 312, 314, 316, and 318 that can be performed using the networked environment 100 of FIG. 1, in accordance with some embodiments of the present disclosure.

As shown in the FIG. 3, the platform 134 allows the seller 106 to perform tasks, not limited to, 302, 304, 306, 308, 310, 312, 314, 316, and 318. The tasks 302, 304, 306, 308, 310, 312, 314, 316, and 318 mentioned in the dashboard 300 are only examples, any tasks that facilitate and assist the users of the platform 134 to complete the real estate transaction can be included without limitation.

The task 302 in the dashboard 300 refers to “Register an account.” The task 302 allows the seller 106 to register an account using the platform 134. A new user can register an account by getting invited by a registered user (to join a transaction) or by visiting the account creation page. A registered and verified user can use all the options and tasks 302, 304, 306, 308, 310, 312, 314, 316, and 318 in the dashboard 300 to assist, facilitate, and complete the real estate transaction.

The task 304 in the dashboard 300 refers to “Create/edit profiles.” The task 304 allows the seller 106 to create or edit their profile using the platform 134. The seller's profile may either be created at the time of registration or after registration, the seller 106 may update the profile details, such as contact details, etc.

The task 306 in the dashboard 300 refers to “List a property.” The task 306 allows the seller 106 to list a property using the platform 134. The seller 106 may list the property to be sold on the platform 134 either directly or with the help of the agent 114 or attorney 118. Listing the property allows the registered users of the platform 134 to view the property details and take necessary actions to buy the property. Listing of property is not only limited to posting for sale but also includes listing for rent, lease, cleaning, etc.

The task 308 in the dashboard 300 refers to “Check offers for their property.” The task 308 allows the seller 106 to check offer prices for their property using the platform 134. Once the property is listed on the platform 134, the buyer 102 and other users may send an offer price to the seller 106. The offer prices received by the seller 106 for the listed property are available under the task 308. The seller 106 may view the offer prices by clicking the task 308, selecting the offer price, and accepting the same to complete the real estate transaction.

The task 310 in the dashboard 300 refers to “Select agent and attorney.” The task 310 allows the seller 106 to select the agent 114 and/or the attorney 118 using the platform 134. At any time during the process or before listing the property, if the seller 106 likes to include the agent 114 or attorney 118 to assist and facilitate in the completion of the real estate transaction, they may find the agent 114 using the platform 134. The agent 114 and/or the attorney 118 may be found and linked to the property transaction by searching their user names or sending an invite to their email ID or contact number.

The task 312 in the dashboard 300 refers to “Contact a service provider.” The task 312 allows the seller 106 to contact the service providers 122 using the platform 134. The seller 106 may contact the service providers 122 such as, but not limited to, contractors, pest control agencies, land appraisers, HVAC companies, painters, goods packers and movers, real estate agents, attorneys, insurance companies, septic companies, notaries, photographers, lenders, title companies, etc., to avail the services related to the real estate property.

The task 314 in the dashboard 300 refers to “List through FSBO.” The task 314 allows the seller 106 to list through For Sale By Owner (FSBO) using the platform 134. The listing of the property by the seller 106 itself without availing the help of the agent 114 and/or the attorney 118 may be referred to as FSBO.

The task 316 in the dashboard 300 refers to “Chat with other users in a transaction (chat with buyers only if both authorize).” The task 316 allows the seller 106 to communicate with other users in a transaction to collaborate and complete the real estate transaction. This chat is applicable only if a communication connection is established such that both the buyer 102 and the seller 106 in the transaction are authorized by each other.

The task 318 in the dashboard 300 refers to “Search for a property.” The task 318 allows the seller 106 to search for a property using the platform 134. The seller 106 may search properties that are listed in the platform 134, by clicking the task 318 on the dashboard 300. The search may be performed based on, but not limited to, the locality, type of property, price range, etc.

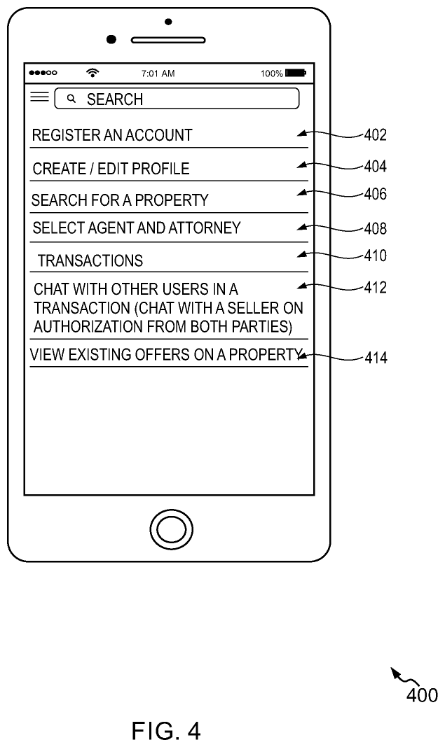

FIG. 4 illustrates a dashboard 400 of the buyer 102 showing a list of tasks 402, 404, 406, 408, 410, 412, and 414 that can be performed using the networked environment 100 of FIG. 1, in accordance with some embodiments of the present disclosure.

As shown in the FIG. 4, the platform 134 allows the buyer 102 to perform the tasks, not limited to, 402, 404, 406, 408, 410, 412, and 414. The tasks 402, 404, 406, 408, 410, 412, and 414 mentioned in the dashboard 400 are only examples, any tasks that facilitate and assist the users of the platform 134 to complete the real estate transaction can also be included.

The task 402 in the dashboard 400 refers to “Register an account.” The task 402 allows the buyer 102 to “Register an account” using the platform 134. A new user may register an account by getting invited by a registered user (to join a transaction) or by visiting the account creation page. A registered and verified user may use all the options and tasks in the dashboard 400 to assist, facilitate, and complete the real estate transaction.

The task 404 in the dashboard 400 refers to “Create/edit profile.” The task 404 allows the buyer 102 to create or edit profile using the platform 134. Buyer's profile may either be created at the time of creating the profile or after creating the profile, the buyer 102 may update the profile details, such as contact details, etc.

The task 406 in the dashboard 400 refers to “Search for a property.” The task 406 allows the buyer 102 to search for a property using the platform 134. The buyer 102 may search properties that are listed in the platform 134, by clicking the task 406 on the dashboard 400. The search may be performed based on, but not limited to, the locality, type of property, price range, etc. The buyer 102 may select the suitable real estate asset based on their requirements and may complete the transaction by placing an offer to the seller 106.

The task 408 in the dashboard 400 refers to “Select agent and attorney.” The task 408 allows the buyer 102 to select the agent 110 or the attorney 118 using the platform 134. At any time during the process, if the buyer 102 likes to include the agent 110 or the attorney 118 to assist and facilitate in the completion of the real estate transaction, the buyer 102 may find the agent 110 using the platform 134. The agent 110 or the attorney 118 may be found and linked to the property transaction by searching their user names or sending an invite to their email ID or contact number.

The task 410 in the dashboard 400 refers to “Transactions.” The task 410 allows the buyer 102 to view a list of real estate transactions using the platform 134. The transactions may include the history of real estate transactions performed by the buyer 102 on the platform 134 with other users. It may be either completed or ongoing transactions.

The task 412 in the dashboard 400 refers to “Chat with other users in a transaction (chat with a seller on authorization from both parties).” The task 412 allows the buyer 102 to communicate with other users who are collaborating to complete the real estate transaction based on a communication connection (e.g., chat) established by the platform 134. This communication connection may be applicable only if both the buyer 102 and the seller 106 in the transaction are authorized by each other.

The task 414 in the dashboard 400 refers to “View existing offers on a property.” The task 414 allows the buyer 102 to view existing offers on a property using the platform 134. Once the property is listed on the platform 134 by the seller 106, the buyers 102 and other users may send an offer (e.g., offer price) to the seller 106. The seller 106 may view the offer prices by clicking the task 308, selecting the offer price, and accepting the same to complete the real estate transaction.

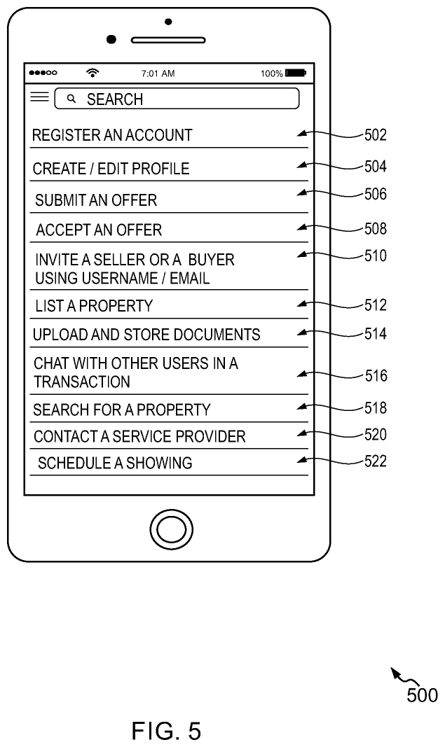

FIG. 5 illustrates a dashboard 500 of the agent 110, 114 showing a list of tasks that can be performed using the networked environment 100 of FIG. 1, in accordance with some embodiments of the present disclosure.

As shown in FIG. 5, the platform 134 allows the agent 110, 114 to perform a list of tasks 502, 504, 506, 508, 510, 512, 514, 516, 518, 520, and 522. The tasks 502, 504, 506, 508, 510, 512, 514, 516, 518, 520, and 522 mentioned in the dashboard 500 are only examples, of any tasks that facilitate and assist the users of the platform 134 to complete the real estate transaction can also be included in the dashboard 500.

The task 502 in the dashboard 500 refers to “Register an account.” The task 502 allows the agent 110, 114 to register an account using the platform 134. A new user may register an account by getting invited by a registered user (to join a transaction) or by visiting the account creation page. A registered and verified user may use all the options and tasks in the dashboard 500 to assist, facilitate, and complete the real estate transaction.

The task 504 in the dashboard 500 refers to “Create/edit profile.” This allows the agent 110, 114 to create or edit profiles using the platform 134. Agent's profile may be created at the time of registration. Any time after registering on the platform 134, the agent 110, 114 may update their profile details, such as contact details, email ID, etc.

The tasks 506 and 508 in the dashboard 500 refer to “Submit an offer” and “Accept an offer,” respectively. This allows the agent 110 to submit an offer price to another user, and the agent 114 to accept an offer price from another user on the platform 134. For example, the agent 110, 114 may send an offer price to the buyer 102 or the seller 106 to facilitate and assist them in the real estate transaction. Further, the dashboard 500 also allows the agent 110, 114 to accept the offer price from other users, for example, the offer from the buyer 102 or the seller 106, thereby the agent 110, 114 may assist the buyer 102 or the seller 106 to complete the real estate transaction.

The task 510 in the dashboard 500 refers to “Invite a seller or a buyer using user name/email.” The task 510 allows agent 110, 114 to invite the buyer 102 or the seller 106 using a user name or email in the platform 134. The agent 110, 114 may invite the buyer 102 or the seller 106 by searching for them using the user name used in the platform 134 or by using their registered email ID. The agent 110, 114 may act on behalf of the buyer 102 or the seller 106 and facilitate the buyer 102 or the seller 106 to complete the real estate transaction based on acceptance of the invitation by the buyer 102 or the seller 106.

The task 512 in the dashboard 500 refers to “List a property.” The task 512 allows the agent 110, 114 to list a property using the platform 134, on behalf of the seller 106. The agent 110(1), 114(1) can list the property to be sold in the platform 134 based on the request received from the seller 106. Listing the property allows the registered users of the platform 134 to view the property details and take necessary actions to buy the property. Listing of property is not only limited to posting for sale but also includes listing for rent, lease, cleaning, etc.

The task 514 in the dashboard 500 refers to “Upload and store documents.” The task 514 allows the agent 110, 114 to upload and store documents using the platform 134. The agent 110, 114 may upload the documents related to the real estate property that the agent 110, 114 is handling and the same may be stored in the platform 134, for example, in the database 130.

The task 516 in the dashboard 500 refers to “Chat with other users in a transaction.” The task 516 allows the agent 110, 114 to communicate with other users who are collaborating to complete the real estate transaction.

The task 518 in the dashboard 500 refers to “Search for a property.” The task 518 allows the agent 110, 114 to search for a property using the platform 134. The agent 110, 114 may search properties that are listed in the platform 134, by clicking the task 518 on the dashboard 500. The search may be performed based on, but not limited to, the locality, type of property, price range, etc. The agent 110, 114 may select the suitable real estate asset based on the requirements of the buyer 102 and may complete the transaction by placing an offer to the seller 106. In an embodiment, the digital platform 134 may allow the agent 110, 114 to show that they are active or available in a particular area to show properties or meet. The agent 110, 114 may be able to enable or disable this feature in the digital platform 134.

The task 520 in the dashboard 500 refers to “Contact a service provider.” The task 520 allows the agent 110, 114 to contact the service provider 122 using the platform 134. The agent 110, 114 may contact the service providers 122 to avail the services related to the real estate asset. The agent 114 of the seller 106 or the agent 110 of the buyer 102 may be refunded with the amount spent on the services rendered by the service provider 122.

The task 522 in the dashboard 500 refers to “Schedule a showing.” The task 522 allows the agent 110, 114 to schedule a showing of property using the platform 134. The agent 110 of the buyer 102 may show the real estate property of the seller 106 to the buyer 102, by scheduling the showing time in advance. The buyer 102, the seller 106, and the agent 110, 114 may meet at the real estate property at the scheduled time. The agent 110, 114 may assist and facilitate the buyer 102 by showing the essential real estate features, for example, the selling parameters that are mentioned in the listing on the digital platform 134, and clarifying the doubts about the property. Alternatively, the agent 110 of the buyer 102 may schedule a virtual showing of the real estate property.

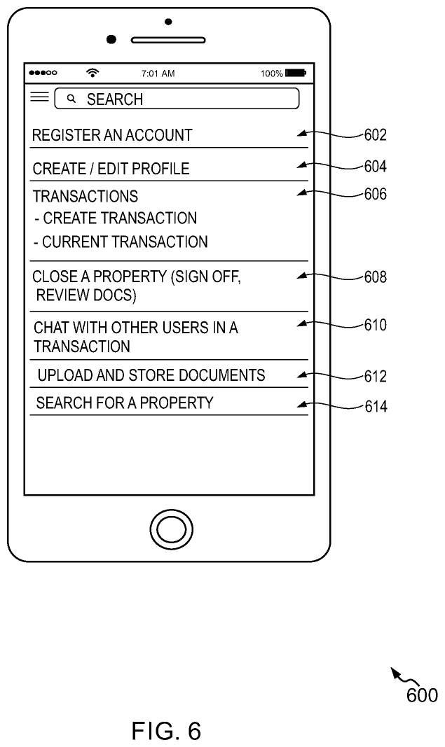

FIG. 6 illustrates a dashboard 600 of the attorney 118 showing a list of tasks that can be performed by the attorney 118 using the networked environment 100 of FIG. 1, in accordance with some embodiments of the present disclosure.

As shown in the FIG. 6, the platform 134 allows attorney 118 to perform a list of tasks 602, 604, 606, 608, 610, 612, and 614. The tasks 602, 604, 606, 608, 610, 612, and 614 mentioned in the dashboard 600 are only examples, any tasks that facilitate and assist the users of the platform 134 to complete the real estate transaction can also be included.

The task 602 in the dashboard 600 refers to “Register an account.” The task 602 allows the attorney 118 to register an account using the platform 134. A new user may register an account by getting invited by a registered user (to join a transaction) or by visiting the account creation page. A registered and verified user may use all options and tasks 602, 604, 606, 608, 610, 612, and 614 in the dashboard 600 to assist, facilitate, and complete the real estate transaction.

The task 604 in the dashboard 600 refers to “Create/edit profile.” The task 604 allows the attorney 118 to create or edit profile using the platform 134. Attorney's profile may be created at the time of registration. Any time after registering at the platform 134, the attorney 118 may update the profile details, such as contact details, email ID, etc.

The task 606 in the dashboard 600 refers to “Transactions.” The task 606 allows the attorney 118 to view a list of real estate transactions using the platform 134. The transactions may include the history of real estate transactions performed by the buyer 102 or the seller 106 in the platform 134 with other users. It may be either completed or ongoing (current) transactions.

The task 608 in the dashboard 600 refers to “Close a property (sign off, review documents).” The task 608 allows the attorney 118 to close the property after signing off and reviewing documents, using the platform 134. The attorney 118 may get a notification if a contract is submitted for review. Once the offer price is accepted, the seller's attorney 118 may be sent an alert to sign off the contract and close the property. Once an offer price is accepted and confirmed, a transaction ID may be issued, which may be used to invite any other user involved in the transaction.

The task 610 in the dashboard 600 refers to “Chat with other users in a transaction.” The task 610 allows the attorney 118 to communicate with other users in a transaction in the platform 134. All users in a specific transaction will be able to communicate with one another in a group-like chat to monitor the progress of the transaction where updates may be sent to all the involved users.

The task 612 in the dashboard 600 refers to “Upload and store documents.” The task 612 allows the attorney 118 to upload and store documents in the platform 134. For example, the attorney 118 may upload the documents related to the real estate property that the attorney 118 is handling and the same may be stored in the platform 134.

The task 614 in the dashboard 600 refers to “Search for a property.” The task 614 allows the attorney 118 to search for the property using the platform 134. The attorney 118 may search for properties that are listed in the platform 134, by clicking the task 614 on the dashboard 600. The search may be performed based on, but not limited to, the locality, type of property, price range, etc.

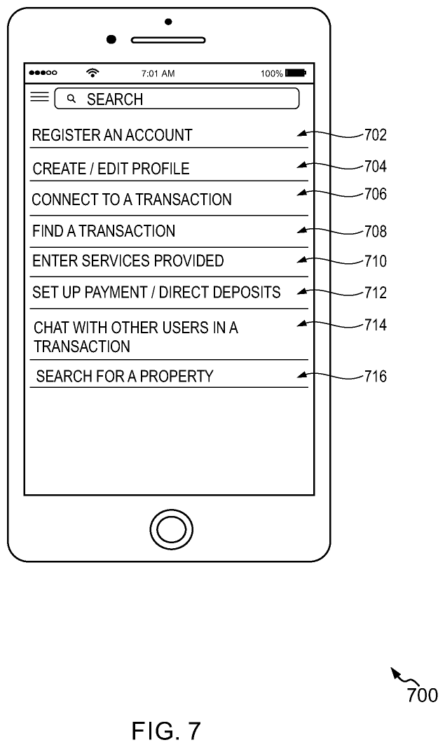

FIG. 7 illustrates a dashboard 700 of a service provider 122 showing a list of tasks that can be performed using the networked environment 100 of FIG. 1, in accordance with some embodiments of the present disclosure.

As shown in the FIG. 7, the platform 134 allows the service provider 122 to perform a list of tasks 702, 704, 706, 708, 710, 712, 714, and 716. The tasks 702, 704, 706, 708, 710, 712, 714, and 716 mentioned in the dashboard 700 are only examples, any tasks that facilitate and assist the users of the platform 134 to complete the real estate transaction can also be included.

The task 702 in the dashboard 700 refers to “Register an account.” The task 702 allows the service provider 122 to register an account using the platform 134. A new user may register an account by getting invited by a registered user (to join a transaction) or by visiting the account creation page. A registered and verified user may use all the options in the dashboard 700 and tasks to assist, facilitate, and complete the real estate transaction.

The task 704 in the dashboard 700 refers to “Create/edit profile.” The task 704 allows the service provider 122 to create or edit profile using the platform 134. Service provider's profile may either be created at the time of registration or any time after registering in the platform 134. The service provider 122 may update the profile details, such as contact details, email ID, etc. any time after the registration process.

The task 706 in the dashboard 700 refers to “Connect to a Transaction.” The task 706 allows the service provider 122 to view the list of transactions and connect with the respective users to complete the real estate transaction, using the platform 134. The transactions may include completed, and current or ongoing transactions between the registered users of the platform 134, who are involved in the real-time transaction.

The task 708 in the dashboard 700 refers to “Find a Transaction.” The task 708 allows the service provider 122 to find the current or complete transactions using the platform 134. The dashboard 700 allows the service provider 122 to search and find a transaction using the transaction ID or user details, like user name, user ID, registered email ID, etc.

The task 710 in the dashboard 700 refers to “Enter services provided.” The task 710 allows the service provider 122 to enter services provided, using the platform 134. At the time of the creation of the profile, one or more services offered may be added by the service provider 122. At any time after registration, the service provider 122 may add additional services provided by clicking the task 710. It should be noted that the services rendered by the service provider 122 may be, but not limited to, painting works, cooling works, goods packers and movers, insurance services, photography services, etc.

The task 712 in the dashboard 700 refers to “Set up a payment or direct deposits.” The task 712 allows the service provider 122 to set up a payment method or direct deposit options or point of sale system using the platform 134. The service provider 122 may set a payment method in the digital platform 134 for using the real estate transaction and collaboration system 138. The buyer 102 or seller 106 may select the suitable payment option either at the time when a service from the service provider 122 is selected or once the service is completed by the service provider 122. In an embodiment, the service provider 122 may request a direct deposit of money from the buyer 102/seller 106 who avails the services of the service provider 122. The service provider 122 may be able to track invoices and expenses on the digital platform 134. The service provider 122 may be able to track earnings. In an embodiment, the service provider 122 may be able to utilize advertising techniques such as, push notifications and/or mailers, to potential users.

The task 714 in the dashboard 700 refers to “Chat with other users in a transaction.” The task 714 allows the service provider 122 to communicate with other users in the transaction using the platform 134. All users in a specific transaction may be able to communicate with one another in a group-like chat to monitor the progress of the transaction, where updates may be sent to all the involved users.

The task 716 in the dashboard 700 refers to “Search for a property.” The task 716 allows the service provider 122 to search for a property using the platform 134. The service provider 122 may search for properties that are listed in the platform 134, by clicking the task 716 on the dashboard 700. The search may be performed based on, but not limited to, the locality, type of property, price range, etc.

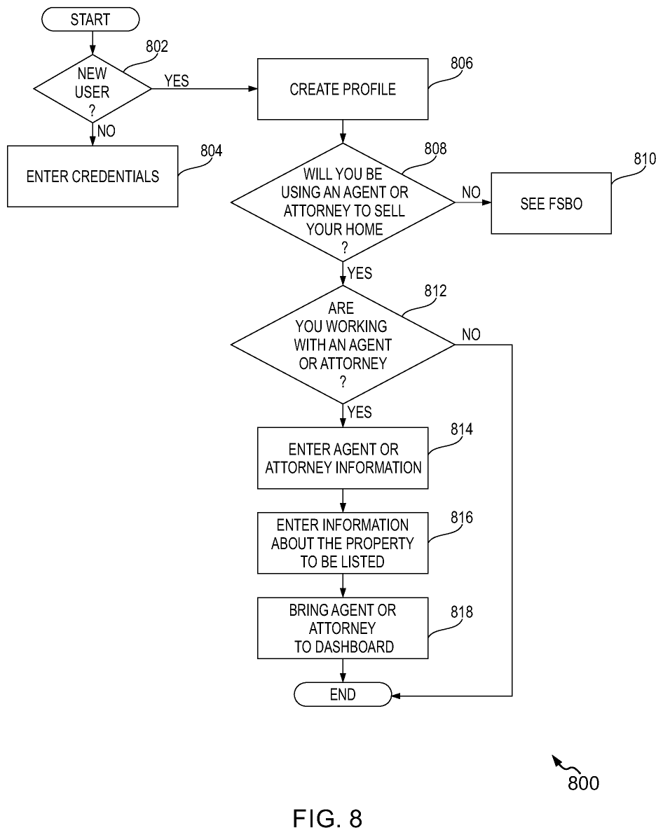

FIG. 8 illustrates a flow chart of a method 800 performed by the seller 106 for viewing existing offers on the property and completing the transaction successfully by connecting with the agent 114 and the attorney 118 using the networked environment 100 of FIG. 1, in accordance with some embodiments of the present disclosure.

The method 800 provides steps for the seller 106 to register an account, create a profile, select the agent 114 or the attorney 118, and contact the service provider 122. Assuming that the first user (e.g., seller 106) wishes to sell their property using the networked environment 100 of FIG. 1.

Initially, as soon as the first user 106 enters the platform 134, at step 802, the method 800 includes checking whether the first user 106 is a new user or not. In case the first user 106 is an existing user, as in step 804, the method 800 includes allowing the first user 106 to enter user credentials to log in and use the online real estate transaction and collaboration system 138. In case the first user 106 is new, as in step 806, the first user 106 registers an account by using an invite from an existing user or by visiting the account creation page. The first user 106 may opt to sell the property using the agent 114 or opt to sell the property on their own.

It should be noted that the seller-related data or details that need to be entered to the platform 134 at the time of registration include, but are not limited to, legal name, address, verifiable email address, and phone number. Any unregistered user invited by another registered user may need to create a profile and only then they may be linked and able to communicate with each other. A transaction ID may be used to locate a specific transaction if the user has multiple deals with different parties.

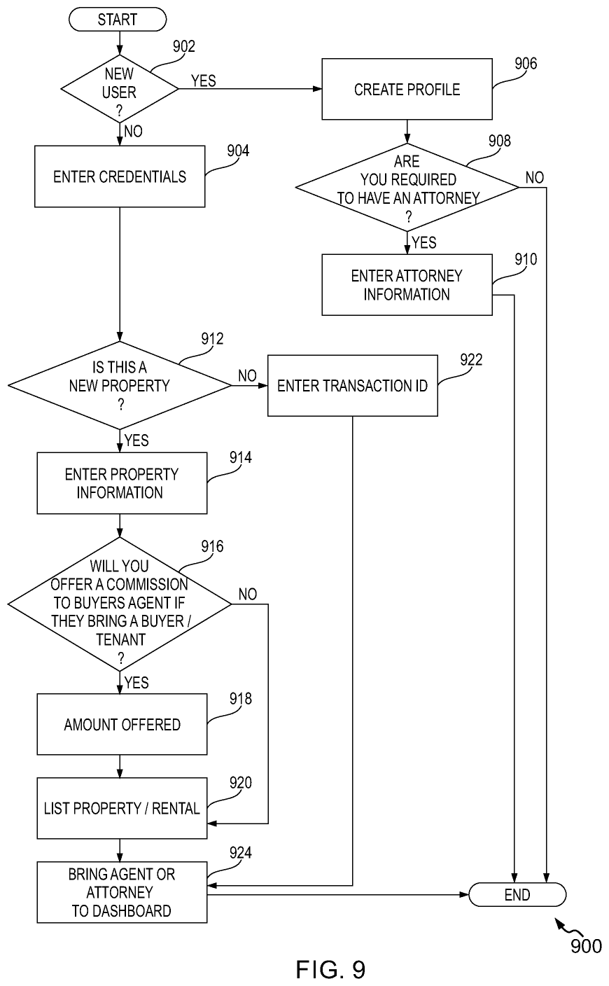

In step 808, the method 800 includes checking whether the first user 106 wishes to use the agent 114 or the attorney 118 to assist in selling the property. As in step 810, if the first user 106 is not willing to use the agent 114 or the attorney 118, the first user 106 may automatically be routed to “for sale by owner” process, as described in method 900 of FIG. 9.

At the time during the process, if the first user 106 would like to engage an agent 114 or an attorney 118, the first user 106 may have an option called “find an agent/attorney” on the digital platform 134. The first user 106 may find the agent 114 by clicking the task 310 in dashboard 300, as shown in FIG. 3.

In step 812, the method 800 includes checking whether the first user 106 wishes to have the agent 114 or the attorney 118 to assist and facilitate real estate transactions. The seller 106 may use the platform 134 to find the agent 114 and associate the agent 114 and/or the attorney 118 to the property transaction. The seller 106 may find a suitable agent 114 or attorney 118 by submitting a query on the digital platform 134, for example, by searching their user name or sending an invite to their email ID or contact number, as in step 814.

The first user 106 may enter the set of selling parameters of the real estate property that they wish to sell and the same may be listed at the platform 134, as at step 816 of the method 800.

In one embodiment, once the agent 114 or the attorney 118 is selected, the information and/or the selling parameters about the property may be fetched from the MLS or may be entered by the first user 106. This may help the digital platform 134 to give a more accurate estimate for the price of the property. The price of the property may be estimated further based on data of other properties that are similar and close to this property. The first user 106 may be able to change the selling parameters on the platform 134, accordingly, the price may reflect those changes based on the options the first user 106 selects. The first user 106 may be able to see the offer prices made on their property in real time.

The seller 106 may send messages to the agent 114, the attorney 118, and the buyer (on authorization) 102 based on a communication connection established by the digital platform 134 for any consultation or decision on the offer prices. In an embodiment, the first user 106 may also find the service provider 122 to make property repairs or improvements, if needed, by their user name or by sending an invite to their email ID or contact number. Thus, the users, for example, the agents 114, the attorneys 118, the service providers 122, etc. may be brought to the dashboard of the first user 106, as at step 818.

FIG. 9 illustrates a flow chart of a method 900 performed by the seller 106 or landlord for selling the property without connecting with the agent 114, in accordance with some embodiments of the present disclosure.

Initially, as soon as the first user 106 enters the platform 134, in step 902, the method 900 includes checking whether the first user 106 (seller/landlord) is a new user or not. In case the first user 106 is an existing user, as in step 904, the method 900 includes allowing the first user 106 to enter the user credentials to log in and use the online real estate transaction and collaboration system 138. In case the first user 106 is new, as in step 906, the first user 106 registers an account by using an invite from an existing user or by visiting the account creation page. The first user 106 may opt to sell their property using the agent 114 or opt to sell the property on their own.

In step 908, the method 900 includes checking whether the first user 106 or the landlord wishes to use the attorney 118 to assist in selling their property. As in step 910, if the first user 106 or the landlord likes to include the attorney 118, they may find the attorney 118 using the digital platform 134 by entering the details of the attorney 118. In an embodiment, the first user 106 may need to enter their property details such as, but not limited to, square footage, bedrooms, bathrooms, basement, HVAC, water supply, sewage system, roof, water heater, electrical system, built year, property images, and location. These details may help the platform 134 to estimate the price of the asset. The first user 106 may change these parameters and the estimated price may reflect those changes.

In step 912, after step 904, the method 900 includes checking whether the real estate property is a new property or not. In case the real estate property is new and not listed before in the platform 134, as at step 914, the first user 106 or the landlord may enter the property details. Then, as at step 916, the method 900 includes checking whether the first user 106 or the landlord is willing to offer a commission to the agent 110 of the buyer 102 if they bring the buyer 102 or tenant.

In step 918, if the first user 106 or the landlord is willing to offer a commission amount, the first user 106 or the landlord may specify the commission amount data including the amount that may be offered to the agents 110, 114 for the agency work in case of a successful transaction. Then, the property may be listed at the platform 134, as at step 920.

In case the first user 106 or the landlord is not interested to use the agent 114, they may directly list the property, as at step 920. In step 922, the method 900 includes, if the property is not new or was already listed in the platform 134 before, the first user 106 or landlord may enter the previous transaction ID of the real estate property.

Finally, as at step 924, users, such as the agents 110, 114, the attorneys 118, the service providers 122, etc. may be brought to the dashboard 300 of the seller 106 or landlords.

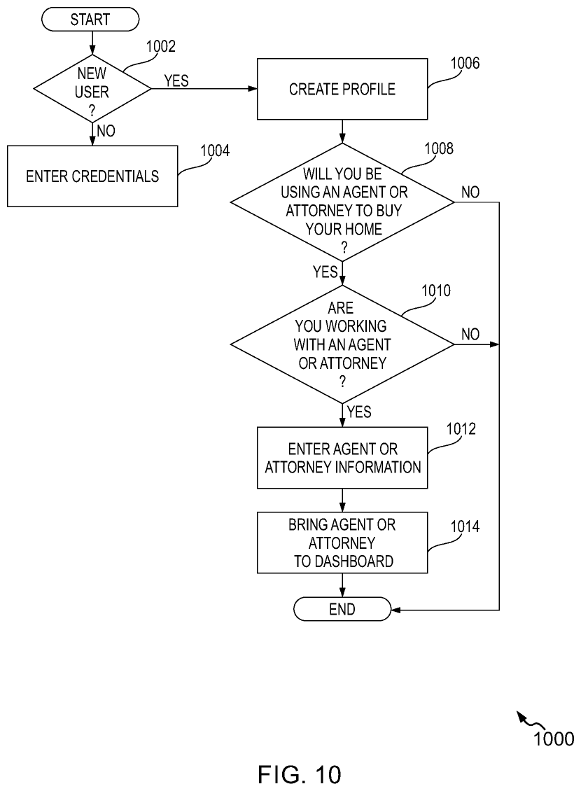

FIG. 10 illustrates a flow chart of a method 1000 performed by the buyer 102 showing the process from creating the profile of the buyer 102 to purchasing the property by connecting to the agent 110 and the attorney 118, in accordance with some embodiments of the present disclosure.

The method 1000 provides steps for the buyer or second user 102 to register an account, create a profile, select the agent 110 or attorney 118, and contact the service provider 122. Assuming that the second user (buyer 102) wishes to buy the property or wishes to get a rented home using the networked environment 100 of FIG. 1.

Initially, as soon as the second user 102 enters the platform 134, in step 1002, the method 1000 includes checking whether the second user 102 (buyer) is a new user or not. In case the second user 102 is an existing user, as in step 1004, the method 1000 includes allowing the second user 102 to enter the user credentials to log in and use the online real estate transaction and collaboration system 138. In case the second user 102 is new, as in step 1006, the second user 102 registers an account by using an invite from an existing user or by visiting the account creation page. The second user 102 may opt to buy the property using the agent 110 or opt to buy the property on their own. Any registered user may locate another registered user by submitting a query including, but not limited to, name, email, user ID, or transaction ID (if they are authorized). It should be noted that the buyers 102, the agents 110, and the attorneys 118 can see current properties on the platform 134 but may not be able to see current offer prices or place offers without registration.

In step 1008, the method 1000 includes checking whether the second user 102 wishes to use the agent 110 or the attorney 118 to assist in buying the property. If the second user 102 is not willing to use the agent 110 or the attorney 118, the first user 102 may automatically be brought to the “For Sale By Owner” process, as described in the method 900 of FIG. 9. At any time during the process, if the second user 102 would like to include the agent 110, they may have to an find the agent 110 using the platform 134, that is, the task 408 in the dashboard 400, as shown in the FIG. 4. The second user 102 may schedule a visit, that is, a tour of the property and an alert may be sent to the respective agent 110 of the second user 102.

In step 1010, the method 1000 includes checking whether the second user 102 wishes to have the agent 110 or the attorney 118 to assist and facilitate in the purchase of the real estate transactions. The second user 102 may use the platform 134 to find an agent 110 and associate the agent 110, and/or the attorney 118 to the property transaction. The second user 102 may find a suitable agent 110 and/or the attorney 118 by submitting a query on the digital platform 134, for example, the query may include their user names or sending an invite to their email ID or contact number, as at step 1012. Further, if the second user 102 confirms that they are not currently working with the agent 110 and/or the attorney 118 and would like to work with them, their information may be shared to locate one for them. Any registered user may locate another registered user by name, email, user ID, or transaction ID if they are authorized.

The digital platform 134 facilitates to establish a communication connection between the plurality of users. The second user 102 may send messages to the agent 110, the attorney 118, and the first user or seller 106 using the communication connection (e.g., chat) for any consultation or decision on the offer prices. The second user 102 may also find the service provider 122 to make property repairs or improvements if needed by entering their user name or by sending an invite to their email ID or contact number. Thus, the users, for example, the agents 110, the attorneys 118, the service providers 122, etc., may be brought to the dashboard 400 of the buyers 102, as at step 1014. The second user 102 may request a time to visit a specific property. If they are currently linked to the agent 110, the request may be sent to that agent 110. If the second user 102 does not have the agent 110, a request to see the property at that specific time may be sent to verified agent 110 that opt-in to receive such alerts. This will essentially be the lead generation portion of the platform 134 for the agents 110.

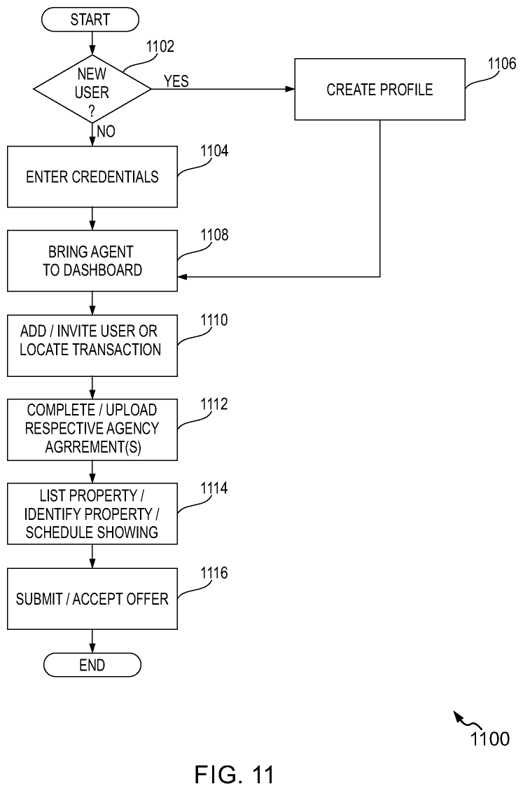

FIG. 11 illustrates a flow chart of a method 1100 performed by the agent 110, 114 for completing the transaction from listing the property to submitting or accepting the offer, in accordance with some embodiments of the present disclosure.

The method 1100 provides steps for the agents 110 or 114 to register an account, create a profile, and contact the buyer 102, the seller 106, and the service provider 122.

Initially, as soon the agent 110, 114 enters the platform 134, in step 1102, the method 1100 includes checking whether the agent 110, 114 is a new user or not. In case the agent 110, 114 is an existing user, as in step 1104, the method 1100 includes allowing the agent 110, 114 to enter the user credentials to log in and use the online real estate transaction and collaboration system 138. In case the agent 110, 114 is a new user, as in step 1106, the agent 110, 114 registers an account by using an invite from an existing user or by visiting the account creation page. Any registered user may locate another registered user by name, email, user ID, or transaction ID (if they are authorized). It should be noted that the details of the agent 110, 114 that need to be entered at the platform 134 at the time of registration include, but are not limited to, name, office address, broker's name, broker's license number, verifiable email address, phone number (both personal and official), and real estate license number.

In step 1108, once the agent 110, 114 is registered with the platform 134 or after logging in with the user credentials, the agent 110, 114 may be shown the dashboard 500 of FIG. 5.

The agent 110, 114 has to be linked to a transaction to help the buyer 102 or the seller 106 to complete the process. This may be done in multiple ways. In step 1110, the agent 110, 114 may be invited by the buyer 102 or the seller 106, respectively, using an email ID or a contact number. Alternatively, the agent 110, 114 may search for a user (seller 106/buyer 102) with their user name on the platform 134. Once the agent 114 is linked to the seller 106, the agent 114 may be able to enter the property information, i.e., the selling parameters using MLS. Using this, the platform 134 may help the seller 106 to determine a list/offer/rental price based on specific selling parameters. It should be noted that in the transaction, the agent 110, 114 may represent and assist at least one of the buyer 102, the seller 106, or the landlord, to complete the real estate transaction.

In step 1112, the method 1100 includes allowing the agents 110 or 114 to upload and store their agency agreements on the platform 134 at the time of profile creation. The present disclosure may not alter or change agents' fiduciary duties with its clients. The agents 110 or 114 may choose to upload and store documents as a backup when registering.

In step 1114, the method 1100 includes allowing the agent 110 of the buyer 102 to communicate with the buyer 110 and schedule a visit time to the property using the open slots in the calendar.

In step 1116, the method 1100 includes allowing the agent 114 to submit an offer price for the property of the seller 106, upon the confirmation of the buyer 102. The agent 114 may be prompted to enter offer information on all offer prices submitted and accepted such as but not limited to, offer price, closing date, type of funding, and which contingencies were elected, if any. Information on current offer prices for the property may be visible to registered users only. The offer end date may be visible to all the users, including unregistered users. Once the agent 110 of the buyer 102 submits the offer price, the agent 114 of the seller 106 communicates with the seller 106 and accepts the best offer.

Once an offer is accepted and confirmed, a transaction ID may be issued, which can be used to invite any other user that may be involved in the transaction. All users in a specific transaction may be able to communicate with one another in a group-like chat to monitor the progress of truncation, where updates may be sent to all the involved users.

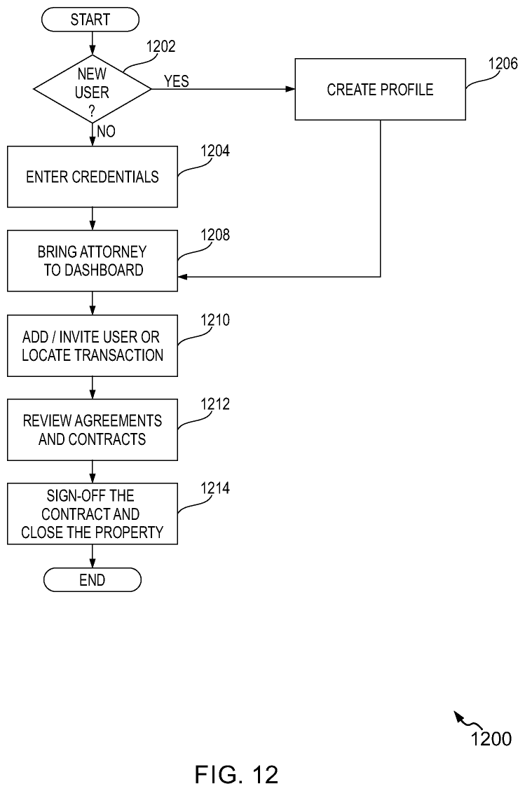

FIG. 12 illustrates a flow chart of a method 1200 performed by the attorney 118 for reviewing, signing off a contract, and closing the property, in accordance with some embodiments of the present disclosure.

The method 1200 provides steps for the attorney 118 to register an account, create a profile, and contact the buyer 102, the seller 106, and the service provider 122 to complete the real estate transaction.

Initially, as soon the attorney 118 enters the platform 134, in step 1202, the method 1200 includes checking whether the user (attorney 118) is a new user or not. In case the attorney 118 is an existing user, as in step 1204, the method 1200 includes allowing the attorney 118 to enter the user credentials to log in and use the online real estate transaction and collaboration system 138. In case the attorney 118 is a new user, as in step 1206, the attorney 118 registers an account by using an invite from an existing user or by visiting the account creation page. To create a profile, the attorney 118 may need to enter their name, address, verifiable email address, phone number, company/law firm information, and states licensed to practice. Any registered user may locate another registered user by name, email, user ID, or transaction ID (if they are authorized).

It should be noted that the details of the attorney 118 that may be entered at the platform 134 at the time of registration include, but are not limited to, name, address, verifiable email address, and phone number (official and personal), company/law firm information, and states in which the attorney 118 is licensed to practice.

Once their profile is verified or a new profile is created, the attorney 118 may be taken to the dashboard 600 of FIG. 6, to use the platform 134 and assist the buyer 102, the seller 106 or the landlords in completing the real estate transaction, as at step 1208.

The attorney 118 may connect to the buyer 102, or the seller 106 using their user name, email, or phone number. If the attorney 118 did not register with an invite of the seller 106 or the buyer 102, the attorney 118 may need to specify if they represent the buyer 102, the seller 106, or the landlord. In step 1210, the method 1200 includes allowing the attorney 118 to add or invite users or locate transactions using the transaction ID. It should be noted that the attorney 118 may represent at least one of the buyer 102, the seller 106, the landlord, or the service provider 122, to assist and complete the real estate transaction.

In step 1212, the method 1200 includes allowing the attorney 118 to get a notification if a contract is submitted for review. Once the offer is accepted, in step 1214, the method 1200 includes allowing the attorney 118 to send an alert to sign off the contract and close the property. Once the offer is accepted and confirmed, a transaction ID may be issued, which may be used to invite any other user that will be involved in the transaction. All users in a specific transaction may be able to communicate with one another in a group-like chat to monitor the progress of the transaction, where updates may be sent to all the involved users.

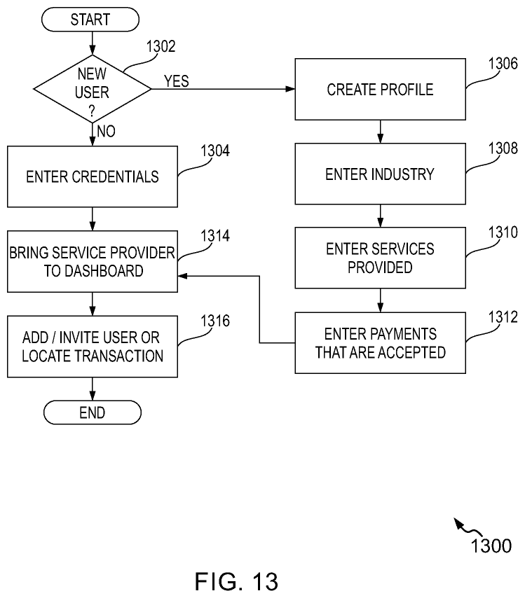

FIG. 13 illustrates a flow chart of a method 1300 performed by the service provider 122 for offering services through the platform 134 and accepting payments for their services, in accordance with some embodiments of the present disclosure.

The method 1300 provides steps for the service provider 122 to register an account, create a profile, and contact the buyer 102, the seller 106, the agent 110, 114, and the attorney 118 to complete the real estate transaction.

Initially, the service provider 122 enters the platform 134, in step 1302, the method 1300 includes checking whether the user (service provider 122) is a new user or not. In case the service provider 122 is an existing user, as in step 1304, the method 1300 includes allowing the service provider 122 to enter the user credentials to log in and use the online real estate transaction and collaboration system 138. In case the service provider 122 is new, as in step 1306, the service provider 122 registers an account by using an invite from an existing user or by visiting the account creation page. Alternatively, the service providers 122 may register an account for themselves and create a profile.

Registered users may be able to locate and the request the service provider 122 for things that they may need during or before their transaction including, but not limited to, contractors, pest control agencies, land appraisers, HVAC companies, painters, goods packers and movers, real estate agents, attorneys, insurance companies, septic companies, notaries, photographers, lenders, title companies, etc.

It should be noted that the details of service provider 122 that may need to be entered at the platform 134 at the time of registration include, but are not limited to, name, address, verifiable email address, phone number (official and personal), company name, services offered, industry in which the service is offered and type of payment methods that can be accepted for the service rendered by them.

In steps 1308 and 1310, the method 1300 includes allowing the service provider 122 to choose what industry and services they provide, the service providers 122 must confirm that they are allowed to offer such services, the service providers 122 can become a verified provider by uploading the necessary documents such as credentials/insurance information.

In step 1312, the method 1300 includes allowing the service provider 122 to set up a direct deposit account on the platform 134 to receive payments after services are confirmed. It is the responsibility of the seller 106 or the agent 110, 114 to confirm that the service providers 122 are allowed to offer the services they are requesting.

In step 1314, once the profile is created or existing user credentials are verified, the platform 134 directs the service provider 122 to the dashboard 700 of FIG. 7. The service provider 122 may connect to another user (seller 106 or an agent 110, 114) to offer their services.

In step 1316, the method 1300 includes allowing the service provider 122 to add or invite or locate real estate transactions. The service provider 122 may upload and send the invoice to other users. Further, the service providers 122 may let their clients know what type of payments they accept for their services, e.g., credit cards, and Cryptocurrency (where legally allowed). The service providers 122 may be able to pick areas they service by zip codes/countries if a provider's service area changes, they may be able to remove and add as needed.

After three verifiable instances where the service provider 122 accepts another user's request for services and does not, in good faith, complete the services requested, that particular service provider's account may be deactivated. Additionally, the service provider 122 may communicate with other users involved in the transaction using the communication connection (e.g., chat feature) of the platform 134.

It should be noted that the users of the platform 134 are not limited to the buyers 102, the sellers 106, the agents 110 or 114, the attorneys 118, the service providers 122, other users, such as lenders, closing agents, etc., may also be collaborated with the platform 134 to facilitate users in completing the real estate transaction. The lenders, closing agents, and other users can share details such as, but not limited to, name, address, verifiable email address, and phone number (official and personal) at the time of registration and use their respective dashboard options or tasks for collaborating with other users.

The users other than the buyers 102 or the sellers 106 that create a profile for their company and/or team may be able to add other registered users under their “Team.” The team leader of the “Team” may have to verify and accept those users. This feature may be used by the agents 110 or 114 who operate a team, or an entire brokerage, lenders, and their assistants, the attorneys 118 and other firms, etc. Once a user registers and creates a profile, the digital platform 134 may route them to their dashboard, from where they may access the options/buttons/tasks, for example, “Search current homes for sale,” “Find an agent,” “Find an attorney,” “Find a lender,” “Find a service provider,” “Create a transaction,” etc.

The users must provide or upload identification to verify identity. Users who request to see assets with the agent 110, 114, and the service providers 122(1) for the first time, users may have an option to do a quick video call to verify the buyer 102 before showing the property. This feature may enhance the safety of the users. The video call may be logged and saved for a predetermined time period, for example, 180 days, or may be downloaded. Users may choose to upload a profile picture of their choice to their profile on the digital platform 134.

Once a user registers and creates a profile, the platform 134 brings them to their respective dashboard, from there they may access various options or tasks that the platform 134 provides to each user to assist and facilitate the completion of real estate transactions. Thus, the present invention provides transparency in the real estate transaction among other users by collaborating with them in a single platform.

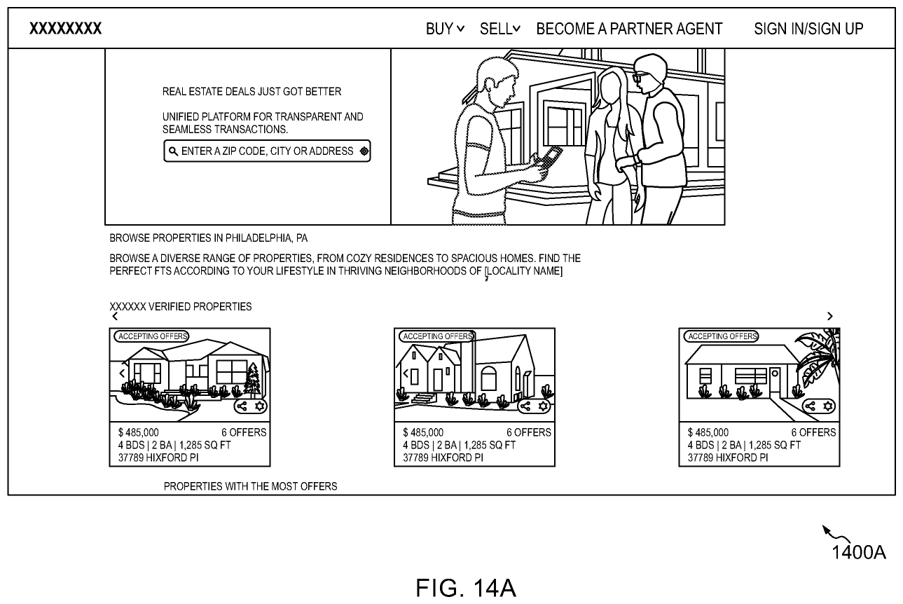

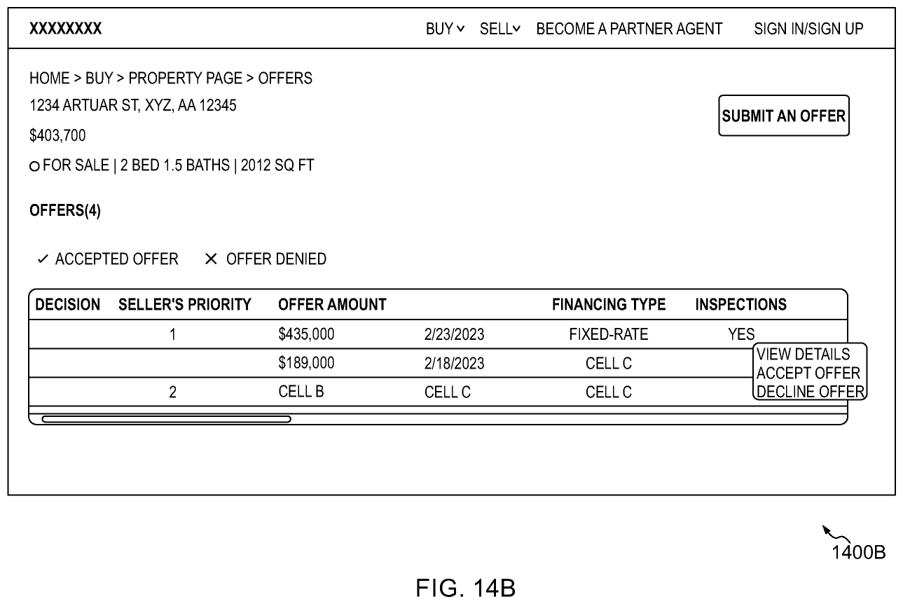

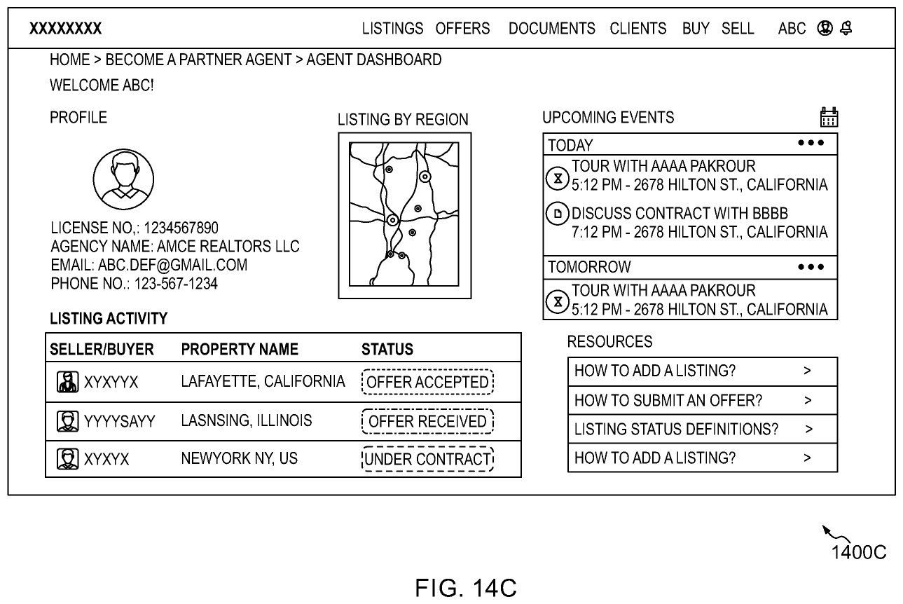

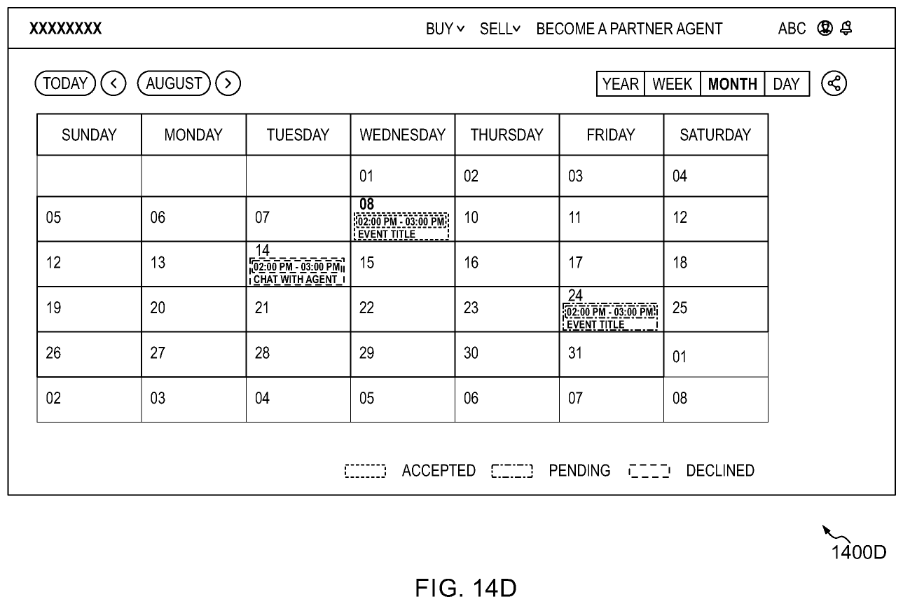

FIGS. 14A-14D illustrate representations of example user interface associated with the system of FIG. 1, in accordance with some embodiments of the present disclosure.

Referring to FIG. 14A, the user interface 1400A shows a landing page of the digital platform 134. In an embodiment, a user may be presented with an option to select a persona for themselves such as, but not limited to, buyer, seller, or partner agent. There may exist more personas such as, but not limited to, auctioneers, service providers, landlords, and the like. Accordingly, the selection of the persona allows the digital platform 134, i.e. the application to customize the user experience based on the selected persona. For example, a buyer persona may allow the user to view a property associated with their user preferences, view other similar properties of interest to the user, perform a valuation of the property, compare different properties, submit offers for the property, and other associated functions. A seller persona may allow the user to submit selling parameters corresponding to an asset that they wish to put up for sale, submit relevant information, and the like. A landlord persona may allow the user manage rental portfolio, upload property information, upload images, list a property for rent, order or approve service repairs or orders, keep track of expenses or repairs and work orders, communicate with service providers 122, receive notifications on repair status, accept and approve rental applications, schedule and accept visit request on their rental properties, receive and store documents related to their rentals and applications, set up and send automatic reminders to tenants for payment, accept payments, assign a representative user to track or manage portfolio, and the like.

Further, the user may be presented with options to either login on the digital platform 134 using credentials or using biometric authentication such as, but not limited to, fingerprint or facial recognition. This provides an added layer of security to ensure that only authorized users can access the information within the digital platform 134.

In an embodiment, the user may register themselves with the digital platform 134. By selecting this option, the user may be redirected to a registration form where they may provide their personal details such as, but not limited to, name, email address, phone number, and desired password. In an embodiment, the user may receive a code for verification or authentication for security purposes to protect their personal details. Based on the verification, the user may be able to access the digital platform 134 to perform desired services.

In case the user is already registered with the digital platform 134 and has an existing account, the user may opt for logging in by entering user credentials such as username and password or using biometric authentication. In an embodiment, the digital platform 134, as described previously with reference to FIG. 1, may store the user credentials associated with the user.

In an embodiment, the user may modify their user credentials or information such as username, login identifier, password, etc. associated with the digital platform 134. To enhance the user experience, the user interface 1400A may also incorporate additional features such as, but not limited to, password recovery options, login with social media accounts, or multi-factor authentication. These functionalities may provide users with flexibility and convenience in accessing their accounts and help ensure the security of their personal information.

Therefore, by providing various options for selecting the user persona and login methods, the user interface 1400A aims to improve the user experience, i.e., by providing a personalized and a secure platform for buying and/or selling assets.

Referring to FIG. 14B, the user interface 1400B shows a list of offer prices received by the first user, e.g., the seller 106. As shown, the first user 106 may see the offer information corresponding to each offer including, but not limited to, offer price, financing type, inspections, etc. corresponding to the asset. In another embodiment, the user interface 1400B may be visible to any registered user, apart from the seller 106. For example, the second user, e.g., the buyer 102 may also be able to view the list of offer prices on a particular asset of interest to make an informed decision and submit an offer for the asset accordingly.

Referring to FIG. 14C, the user interface 1400C shows an example profile page of an agent 110, 114. In an embodiment, the digital platform 134 may provide a location of a property on an interactive map. For example, as shown, the user interface 1400C shows listings of the agent 110, 114 on the map. In an embodiment, a mileage tracker may be enabled for users which may be used to provide periodic mileage report, for example, weekly, monthly, annually, etc.

Referring to FIG. 14D, the user interface 1400D shows a calendar view of upcoming scheduled visits for an asset. For example, an agent 110, 114 may be able to block the calendar of the buyer 102 or the seller 106 based on their availability to schedule a visit to the asset. In an embodiment, the user interface 1400D may depict a current status corresponding to each scheduled visit, for example, accepted, pending, or declined.

It may be appreciated that the example representations of the user interface (1400A-1400D) may be modular and flexible to accommodate any kind of changes within the scope of the present disclosure.

Therefore, the present disclosure provides a comprehensive and innovative solution for asset sales and purchases through an advanced digital platform. The embodiments described herein deliver a seamless and efficient user experience. It is important to note that while the embodiments discussed primarily focus on real estate properties, the inventive concepts and features presented herein are applicable to various asset categories. Whether it is automobiles, boats, luxury items, or any other valuable asset, the principles and functionalities described in this disclosure may be adaptable and scalable to cater to diverse asset markets.

In summary, the present disclosure revolutionizes the asset sales and purchase industry by introducing a technologically advanced platform that optimizes the user experience and facilitates comprehensive asset information access, and collaboration between various stakeholders. Its versatility makes it suitable for a wide range of asset categories, ensuring that buyers and sellers in various markets can benefit from its functionalities and features. By integrating all processes and platforms, the property buying process is simplified, making it more efficient by being an all-in-one platform such that the user may not have to wait or depend on others, i.e. agents, brokers, etc. for the process.

The methods described herein may be performed using the systems described herein. In addition, it is contemplated that the methods described herein may be performed using systems different than the systems described herein. Moreover, the systems described herein may perform the methods described herein and may perform or execute instructions stored in a non-transitory computer-readable storage medium (CRSM). The CRSM may comprise any electronic, magnetic, optical, or other physical storage device that stores executable instructions. The instructions may comprise instructions to cause a processor to perform or control performance of operations of the proposed methods. It is also contemplated that the systems described herein may perform functions or execute instructions other than those described in relation to the methods and CRSMs described herein.

Furthermore, the CRSMs described herein may store instructions corresponding to the methods described herein and may store instructions which may be performed or executed by the systems described herein. Furthermore, it is contemplated that the CRSMs described herein may store instructions different than those corresponding to the methods described herein, and may store instructions which may be performed by systems other than the systems described herein.

The methods, systems, and CRSMs described herein may include the features or perform the functions described herein in association with any one or more of the other methods, systems, and CRSMs described herein.

In an embodiment, the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above-described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above-described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

1. A computer-implemented method, comprising:
receiving, by a processor associated with a digital platform, from a plurality of users associated with respective user devices, user credentials for the digital platform;
authenticating, by the processor, the plurality of users based on the user credentials;
receiving, by the processor, a set of selling parameters corresponding to an asset from a first user, of the plurality of users, associated with a first user device;
dynamically estimating, by the processor, a price of the asset based at least on the set of selling parameters;
displaying, by the processor, the asset and the set of selling parameters on the respective user devices of the plurality of users via the digital platform;
receiving, by the processor, one or more offer prices for the asset from one or more second users, of the plurality of users, associated with one or more second user devices; and
establishing, by the processor, a communication connection between the plurality of users including the first user and the one or more second users to enable the first user and the one or more second users to complete a transaction of the asset via the digital platform.

2. The computer-implemented method of claim 1, wherein the price of the asset is further based on one or more similar assets located within a predetermined area from the asset.

3. The computer-implemented method of claim 1, further comprising:
displaying, by the processor, the one or more offer prices, received from the one or more second users, in real-time on the respective user devices of the plurality of users via the digital platform.

4. The computer-implemented method of claim 1, further comprising:
receiving, by the processor, a query to search for an agent on the digital platform;
displaying, by the processor, a list of agents associated with the digital platform based on the query;
receiving, by the processor, a selection of the agent from the list of agents;
associating, by the processor, the selected agent with an identifier of the transaction of the asset; and
establishing, by the processor, the communication connection between the first user, the one or more second users, and the agent to facilitate the completion of the transaction of the asset.

5. The computer-implemented method of claim 4, wherein the query is received from at least one of the first user of the first user device, and the one or more second users of the one or more second user devices.

6. The computer-implemented method of claim 4, wherein the query comprises at least one of username of the agent, e-mail identifier (ID) of the agent, the identifier of the transaction, or any combination thereof.

7. The computer-implemented method of claim 4, wherein establishing, by the processor, the communication connection comprises:
receiving, by the processor, from the one or more second users, a tour request corresponding to the asset; and
scheduling, by the processor, a tour of the asset based on an availability of the first user, the one or more second users, and the agent.

8. The computer-implemented method of claim 4, further comprising receiving, by the processor, from the one or more second users via the agent, offer information corresponding to the one or more offer prices.

9. The computer-implemented method of claim 8, wherein the offer information comprises at least one of: offer price, closing date, type of funding, elected contingencies, or any combination thereof.

10. The computer-implemented method of claim 4, further comprising:
receiving, by the processor, from the first user of the first user device via the agent, a selection of an offer price from the one or more offer prices.

11. The computer-implemented method of claim 10, further comprising receiving, by the processor, from the first user of the first user device, commission amount data corresponding to the selection of the offer price.

12. The computer-implemented method of claim 1, wherein the set of selling parameters comprises information corresponding to at least one of square footage, number of bedrooms, number of bathrooms, basement, Heating, Ventilation, and Air Conditioning (HVAC) system, water supply, sewage system, roof, water heater, electrical system, built year, images of the asset, location, or any combination thereof.

13. The computer-implemented method of claim 1, wherein the plurality of users comprises at least one of buyers, sellers, agents of the buyers, agents of the sellers, attorneys, landlords, and service providers, wherein the first user corresponds to the sellers, and wherein the one or more second users corresponds to the buyers.

14. A system for facilitating completion of an asset transaction, comprising:
a processor; and
a memory operatively coupled with the processor, wherein the memory comprises processor-executable instructions which, when executed, cause the processor, at least in part, to:
receive, from a plurality of users associated with respective user devices, user credentials for a digital platform associated with the system;
authenticate the plurality of users based on the user credentials;
receive a set of selling parameters corresponding to an asset from a first user, of the plurality of users, associated with a first user device;
dynamically estimate a price of the asset based at least on the set of selling parameters;
display the asset and the set of selling parameters on the respective user devices of the plurality of users via the digital platform;
receive one or more offer prices for the asset from one or more second users, of the plurality of users, associated with one or more second user devices; and
establish a communication connection between the plurality of users including the first user and the one or more second users to enable the first user and the one or more second users to complete a transaction of the asset via the digital platform.

15. The system of claim 14, wherein the price of the asset is further based on one or more similar assets located within a predetermined area from the asset.

16. The system of claim 14, wherein the memory comprises processor-executable instructions which, when executed, further cause the processor, at least in part, to:
receive a query to search for an agent or attorney on the digital platform;
display a list of agents or attorneys associated with the digital platform based on the query;
receive a selection of the agent or attorney from the list of agents or attorneys;
associate the selected agent or attorney with an identifier of the transaction of the asset; and
establish the communication connection between the first user, the one or more second users, and the agent or attorney to facilitate the completion of the transaction of the asset.

17. The system of claim 16, wherein the query is received from at least one of: the first user of the first user device, and the one or more second users of the one or more second user devices.

18. The system of claim 16, wherein the query comprises at least one of: username of the agent or attorney, e-mail identifier (ID) of the agent or attorney, the identifier of the transaction, or any combination thereof.

19. The system of claim 16, wherein the memory comprises processor-executable instructions which, when executed, further cause the processor to receive, from the first user of the first user device via the selected agent, a selection of an offer price from the one or more offer prices, wherein the first user collaborates with the plurality of users via the established communication connection corresponding to the selected offer price of the asset.

20. A non-transitory computer-readable medium comprising processor-executable instructions that cause a system to:
receive, from a plurality of users associated with respective user devices, user credentials for a digital platform associated with the system;
authenticate the plurality of users based on the user credentials;
receive a set of selling parameters corresponding to an asset from a first user, of the plurality of users, associated with a first user device;
dynamically estimate a price of the asset based at least on the set of selling parameters;
display the asset and the set of selling parameters on the respective user devices of the plurality of users via the digital platform;
receive one or more offer prices for the asset from one or more second users, of the plurality of users, associated with one or more second user devices; and
establish a communication connection between the plurality of users including the first user and the one or more second users to enable the first user and the one or more second users to complete a transaction of the asset via the digital platform.
